(19) United States
(12) Patent Application Publication
(10) Pub. No.: US 2013/0057818 A1
(43) Pub. Date: Mar. 7, 2013

(54) LIQUID CRYSTAL DISPLAY

(71) Applicants: Se Hyoung CHO, Seoul (KR); Hong-Jo PARK, Asan-si (KR); Sung Hoon KIM, Seoul (KR); Dong Gyu KIM, Yongin-si (KR); Dong-Hyeon KI, Asan-si (KR)

(72) Inventors: Se Hyoung CHO, Seoul (KR); Hong-Jo PARK, Asan-si (KR); Sung Hoon KIM, Seoul (KR); Dong Gyu KIM, Yongin-si (KR); Dong-Hyeon KI, Asan-si (KR)

(73) Assignee: SAMSUNG ELECTRONICS CO., LTD., Suwon-si (KR)

(21) Appl. No.: 13/414,125

(22) Filed: Mar. 7, 2012

(30) Foreign Application Priority Data
Sep. 1, 2011 (KR) 10-2011-0088374

(51) Int. Cl. G02F 1/1343

(52) U.S. Cl. 349/141

(57) ABSTRACT

A liquid crystal display includes: two opposing substrates; a liquid crystal layer interposed between the two substrates and including liquid crystal molecules; a gate line which transfers a gate signal; a data line which transfers a data voltage; a voltage transfer line which transfers a voltage having a predetermined magnitude; and pixels, each including first and second pixel electrodes separated from each other, where the first pixel electrode includes first and second subpixel electrode, the second pixel electrode includes third and fourth subpixel electrodes, each of the first to fourth subpixel electrodes includes a stem and branch electrodes, the branch electrodes of the first and third subpixel electrodes are alternately disposed, the branch electrodes of the second and fourth subpixel electrodes are alternately disposed, and a voltage difference between the first and second pixel electrodes is greater than a voltage difference between the second and fourth subpixel electrodes.

This application claims priority to Korean Patent Application No. 10-2011-0088374 filed on Sep. 1, 2011, and all the benefits accruing therefrom under 35 U.S.C. §119, the content of which in its entirety is herein incorporated by reference.

### BACKGROUND OF THE INVENTION

(a) Field of the Invention

Exemplary embodiments of the invention relates to a liquid crystal display.

(b) Description of the Related Art

A liquid crystal display panel, which is one of the most widely used types of flat panel displays, typically includes two opposing panels, on which field generating electrodes, such as a pixel electrode and a common electrode are provided, and a liquid crystal layer interposed between the two opposing panels. The liquid crystal display generates electric fields in the liquid crystal layer by applying voltage to the field generating electrodes, and determines the direction of liquid crystal molecules of the liquid crystal layer by the generated electric field such that polarization of incident light is controlled to display images.

The liquid crystal display may be implemented to have a high contrast ratio, an improved wide viewing angle, and a rapid response speed to improve display quality of the liquid crystal display.

Among the liquid crystal displays, a vertically aligned mode liquid crystal display, in which a longitudinal axis of the liquid crystal molecules is arranged to be perpendicular to upper and lower display panels in a state, in which an electric field is not applied, may have a high contrast ratio and easily implement a wide reference viewing angle thereof.

In the vertical alignment mode liquid crystal display, side visibility may deteriorate as compared with front visibility.

### BRIEF SUMMARY OF THE INVENTION

Exemplary embodiments of the invention relate to a liquid crystal display having high contrast ratio and wide viewing and with increased response speed of liquid crystal molecules and improved side visibility.

An exemplary embodiment of the invention provides a liquid crystal display including: a first substrate; a second substrate disposed opposite to the first substrate; a liquid crystal layer interposed between the first and second substrates and including liquid crystal molecules; a gate line disposed on the first substrate and which transfers a gate signal; a data line disposed on the first substrate and which transfers a data voltage; a voltage transfer line disposed on the first substrate and which transfers a voltage having a predetermined magnitude; and a plurality of pixels disposed on the first substrate, where each of the pixels includes a first pixel electrode and a second pixel electrode separated from each other, where the first pixel electrode includes a first subpixel electrode and a second subpixel electrode, where the second pixel electrode includes a third subpixel electrode and a fourth subpixel electrode, where each of the first, second, third and fourth subpixel electrodes includes a stem and a plurality of branch electrodes protruding from the stem, where the branch electrodes of the first subpixel electrode of the first pixel electrode and the branch electrodes of the third subpixel electrode of the second pixel electrode are alternately disposed, where the branch electrodes of the second subpixel electrode of the first pixel electrode and the branch electrodes of the fourth subpixel electrode of the second pixel electrode are alternately disposed, and where a voltage difference between the first subpixel electrode of the first pixel electrode and the third subpixel electrode of the second pixel electrode is greater than a voltage difference between the second subpixel electrode of the first pixel electrode and the fourth subpixel electrode of the second pixel electrode.

In an exemplary embodiment, the liquid crystal display may further include: a first switching element connected to the first subpixel electrode of the first pixel electrode; a second switching element connected to the second subpixel electrode of the first pixel electrode; a third switching element connected to the third subpixel electrode of the second pixel electrode; and a fourth switching element connected to the fourth subpixel electrode of the second pixel electrode, where the first switching element and the second switching element may be connected to the voltage transfer line and the third switching element and the fourth switching element may be connected to the data line.

In an exemplary embodiment, the liquid crystal display may further include a fifth switching element connected to an output terminal of the second switching element or an output terminal of the third switching element.

In an exemplary embodiment, the fifth switching element may be connected to a gate line different from the first to fourth switching elements.

In an exemplary embodiment, an output terminal of the fifth switching element may be connected to a step-down capacitor.

In an exemplary embodiment, the liquid crystal layer may be substantially vertically aligned when an electric field is not generated in the liquid crystal layer.

In an exemplary embodiment, the liquid crystal display may further include an additional gate line different from the gate line, where the first to fourth switching elements may be connected to the gate line, and the fifth switching element may be connected to the additional gate line.

In an exemplary embodiment, the liquid crystal display may further include a reference voltage line which transfers a reference voltage having a predetermined magnitude, where a control terminal of the fifth switching element may be connected to the reference voltage line.

In an exemplary embodiment, two pixels, adjacent to each other in a pixel column direction of the pixels, may be connected with the voltage transfer line, first subpixel electrodes of the two pixels may be disposed opposite to each other with respect to the voltage transfer line, and second subpixel electrodes of the two pixels may be disposed opposite to each other with respect to the voltage transfer line.

According to an exemplary embodiment of the invention, the high contrast ratio and wide viewing angle of the liquid crystal display may be realized at the same time by including subpixel electrodes which receives voltages having different magnitudes and are alternately disposed, and side visibility is substantially improved by controlling voltage applied to each subpixel electrode to divide one pixel area into a high gray region and a low gray region.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram showing an exemplary embodiment of a liquid crystal display according to the invention;

FIG. 2 is an equivalent circuit diagram showing one pixel of an exemplary embodiment of a liquid crystal display according to the invention;

FIG. 3 is a schematic cross-sectional view of an exemplary embodiment of a liquid crystal display according to the invention;

FIG. 4 is a schematic circuit diagram of one pixel of an exemplary embodiment of a liquid crystal display according to the invention;

FIG. 5 is a waveform diagram of a signal applied to a pixel of the liquid crystal display shown in FIG. 4;

FIG. 6 is a graph illustrating transmittance versus data voltage, showing an example comparing magnitudes of electric fields applied to pixel areas of the liquid crystal display shown in FIGS. 4 and 5;

FIG. 7 is a top plan view of the liquid crystal display according to the exemplary embodiment shown in FIG. 4;

FIG. 8 is a cross-sectional view of the liquid crystal display of FIG. 7 taken along line VIII-VIII;

FIG. 9 is a top plan view showing a plurality of pixels of the liquid crystal display shown in FIGS. 4 and 5;

FIG. 10 is a schematic circuit diagram of one pixel of an alternative exemplary embodiment of a liquid crystal display according to the invention;

FIG. 11 is a waveform diagram of a signal applied to a pixel of the liquid crystal display shown in FIG. 10;

FIG. 12 is a top plan view of the liquid crystal display shown in FIG. 10;

FIG. 13 is a cross-sectional view of the liquid crystal display of FIG. 12 taken along line XIII-XIII;

FIG. 14 is a schematic circuit diagram of one pixel of another alternative exemplary embodiment of a liquid crystal display according to the invention;

FIG. 15 is a top plan view of the liquid crystal display shown in FIG. 14;

FIG. 16 is a cross-sectional view of the liquid crystal display of FIG. 15 taken along line XVI-XVI;

FIG. 17 is a schematic circuit diagram of one pixel of yet another alternative exemplary embodiment of a liquid crystal display according to the invention;

FIG. 18 is a top plan view of the liquid crystal display shown in FIG. 17;

FIG. 19 is a cross-sectional view of the liquid crystal display of FIG. 18 taken along line XIX-XIX;

FIG. 20 is a schematic circuit diagram of one pixel of still another alternative exemplary embodiment of a liquid crystal display according to the invention;

FIG. 21 is a top plan view of the liquid crystal display shown in FIG. 20.

FIG. 22 is a cross-sectional view of the liquid crystal display of FIG. 21 taken along line XXII-XXII;

FIG. 23 is a schematic circuit diagram of one pixel of still yet another alternative exemplary embodiment of a liquid crystal display according to the invention;

FIG. 24 is a top plan view of the liquid crystal display shown in FIG. 23; and

FIG. 25 is a cross-sectional view of the liquid crystal display of FIG. 24 taken along line XXV-XXV;

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of a liquid crystal display according to the invention will be described in detail with reference to the accompanying drawings.

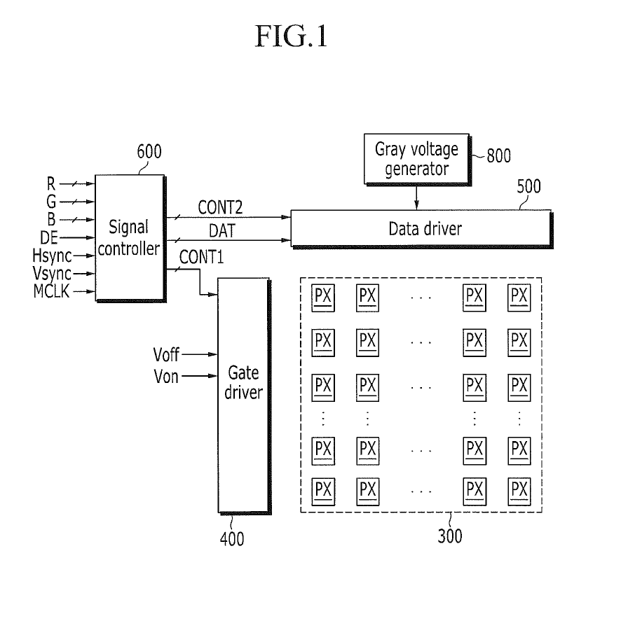

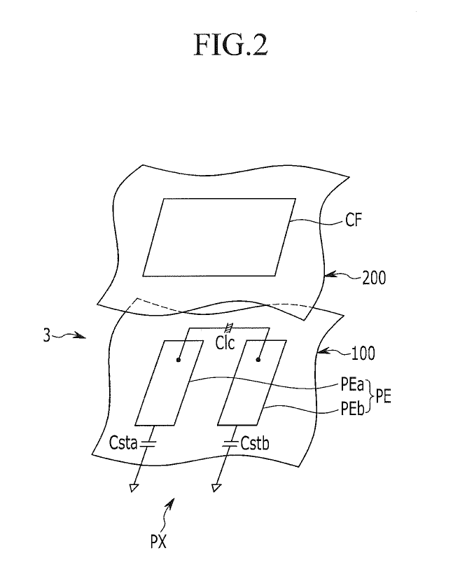

Referring to FIGS. 1 to 3, an exemplary embodiment of a liquid crystal display according to the invention will be described. FIG. 1 is a block diagram showing an exemplary embodiment of a liquid crystal display according to the invention, FIG. 2 is an equivalent circuit diagram showing one pixel of an exemplary embodiment of a liquid crystal display according to the invention, and

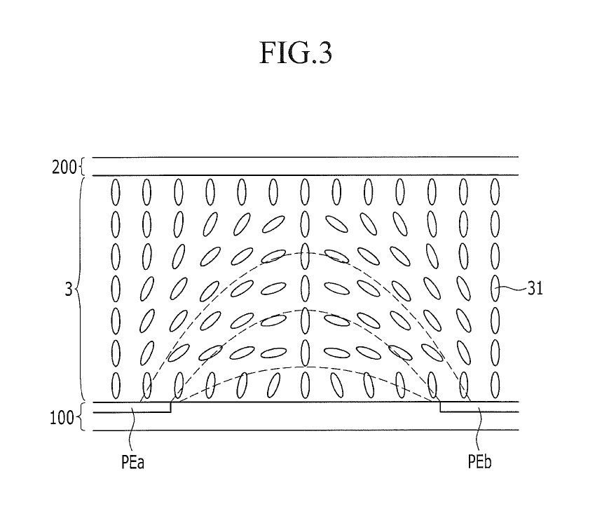

FIG. 3 is a schematic cross-sectional view of an exemplary embodiment of a liquid crystal display according to the invention.

Referring to FIG. 1, an exemplary embodiment of the liquid crystal display according to the invention includes a liquid crystal panel assembly 300, a gate driver 400, a data driver 500, a gray voltage generator 800 and a signal controller 600.

Referring to FIG. 2, the liquid crystal panel assembly 300 includes lower and upper panels 100 and 200 disposed opposite to, e.g., facing, each other and a liquid crystal layer 3 interposed therebetween.

A liquid crystal capacitor Clc includes a first pixel electrode PEa and a second pixel electrode PEb of the lower panel 100 as two terminals thereof and the liquid crystal layer 3 between the first and second pixel electrodes PEa and PEb acts as a dielectric material. In an exemplary embodiment, the first pixel electrode PEa may have a first subpixel electrode and a second subpixel electrode (not shown), and the second pixel electrode PEb may have a third subpixel electrode and a fourth subpixel electrode (not shown). The first subpixel electrode and the third subpixel electrode may collectively define a first pixel area, and the second subpixel electrode and the fourth subpixel electrode may collectively define a second pixel area.

The liquid crystal layer 3 has dielectric anisotropy, and a longitudinal axis of a liquid crystal molecule of the liquid crystal layer 3 may be aligned substantially perpendicular to surfaces of upper and lower panels 100 and 200 when an electric field is not generated therein.

The first pixel electrode PEa and the second pixel electrode PEb may be in different layers or in a same layer. First and the second storage capacitors (not shown), which support the liquid crystal capacitor Clc, may be defined by a separate electrode (not shown) provided in the lower panel 100 overlapping each of the first and second pixel electrodes PEa and PEb with an insulator therebetween. In an alternative exemplary embodiment, the liquid crystal display may include a transparent electrode provided on the upper panel 200 and that receives voltage having a constant magnitude.

In an exemplary embodiment, each pixel PX displays one of the primary colors (spatial division) or each pixel PX alternately displays the primary colors according to time (temporal division) to display a color image such that a desired color may be recognized by a spatial and temporal sum of the primary colors. In an exemplary embodiment, the primary colors may be three primary colors such as red, green and blue, for example. In an exemplary embodiment, each pixel may further display white color other than the three primary colors of red, green and blue. In an exemplary embodiment, as shown in FIG. 2, each pixel PX may include a color filter CF displaying one of the primary colors in an area of the upper panel 200 corresponding to the first and second pixel electrodes PEa and PEb for the spatial division. In an alternative exemplary embodiment, unlike FIG. 2, the color filter CF may be disposed above or below the first and second pixel electrodes PEa and PEb of the lower panel 100.

When voltages are applied to the first pixel electrode PEa and the second pixel electrode PEb, a difference between two voltages applied to the first pixel electrode PEa and the second pixel electrode PEb is shown as charged voltage of the liquid crystal capacitor Clc, that is, a pixel voltage. When a potential difference is generated at both ends of the liquid crystal capacitor Clc, as shown in FIG. 3, an electric field substantially parallel to the surfaces of the panels 100 and 200 is generated in the liquid crystal layer 3 between the first pixel electrode PEa and the second pixel electrode PEb. In one exemplary embodiment, for example, the electric field substantially parallel to the surfaces of the panels 100 and 200 is generated in the liquid crystal layer 3 between the first subpixel electrode of the first pixel electrode PEa and the third subpixel electrode of the second pixel electrode PEb, and the electric field substantially parallel to the surfaces of the panels 100 and 200 may be generated in the liquid crystal layer 3 between the second subpixel electrode of the first pixel electrode PEa and the fourth subpixel electrode of the second pixel electrode PEb. In an exemplary embodiment, when liquid crystal molecules 31 have positive dielectric anisotropy, longitudinal axes of the liquid crystal molecules 31 are inclined to be substantially parallel to a direction of the electric field and an inclined degree thereof varies according to a magnitude of pixel voltage. In such an embodiment, the liquid crystal layer 3 may be referred to as an electrically-induced optical compensation (“EOC”) mode. In an exemplary embodiment, a degree of variation in polarization of light passing the liquid crystal layer 3 varies according to the inclined degree of the liquid crystal molecules 31. The variation in polarization is represented by transmittance variation of light due to a polarizer and as a result, the pixel PX represents desired predetermined luminance.

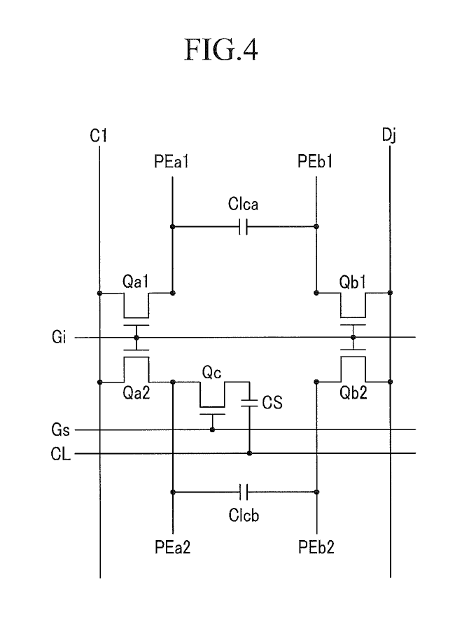

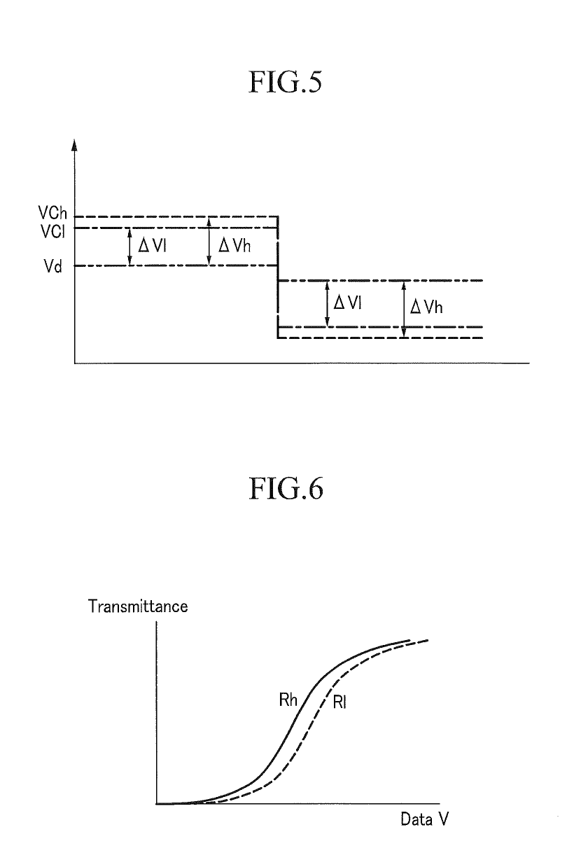

Hereinafter, an exemplary embodiment of a liquid crystal display according to the invention will be described with reference to FIGS. 4 to 6 and again to FIGS. 1 to 3. FIG. 4 is a schematic circuit diagram of one pixel of an exemplary embodiment of a liquid crystal display according to the invention, FIG. 5 is a waveform diagram of a signal applied to a pixel of the liquid crystal display shown in FIG. 4, and FIG. 6 is a graph illustrating transmittance versus data voltage, showing an example comparing intensities of electric fields applied to pixel areas of the liquid crystal display shown in FIGS. 4 and 5.

Referring to FIGS. 1 and 4, an exemplary embodiment of the liquid crystal display includes a plurality of signal lines Gi, Gs, CL, C1 and Dj and a plurality of pixels PX connected thereto and arranged substantially in a matrix form when viewed from a schematic circuit diagram.

The signal lines Gi, Gs, CL, C1, and Dj include a gate line and an auxiliary gate line Gs that transfer gate signals (also, referred to as “scanning signals”), a data line Dj that transfers data voltages, a voltage transfer line C1 that transfers a voltage having a constant magnitude, and a capacitor voltage line (capacitor electrode lines) CL that transfers a voltage having a constant magnitude.

Each pixel PX includes a first switching element Qa1, a second switching element Qa2, a third switching element Qb1, a fourth switching element Qb2 and a fifth switching element Qc, which are connected to the signal lines Gi, Gs, CL, C1 and Dj, and a first liquid crystal capacitor Cla and a second liquid crystal capacitor Clb, which are connected to the first switching element Qa1, the second switching element Qa2, the third switching element Qb1, the fourth switching element Qb2 and the fifth switching element Qc.

In an exemplary embodiment, the first switching element Qa1, the second switching element Qa2, the third switching element Qb1, the fourth switching element Qb2 and the fifth switching element Qc are three-terminal elements, such as a thin film transistor, provided on the lower panel 100. The first switching element Qa1 and the second switching element Qa2 include control terminals connected to the gate line Gi, input terminals connected to the voltage transfer line C1, and output terminals connected to a first subpixel electrode PEa1 and a second subpixel electrode PEa2 of the first pixel electrode PEa. The third switching element Qb1 and the fourth switching element Qb2 include control terminals connected to the gate line Gi, input terminals connected to the data line Dj, and output terminals connected to a third subpixel electrode PEb1 and a fourth subpixel electrode PEb2 of the second pixel electrode PEb. A control terminal of the fifth switching element Qc is connected to the auxiliary gate line Gs, an input terminal of the fifth switching element Qc is connected to an output terminal of the second switching element Qa2, and an output terminal of the second switching element Qa2 is connected to a step-down capacitor CS.

The first liquid crystal capacitor Clca is connected to the first subpixel electrode PEa1 of the first pixel electrode PEa and the third subpixel electrode PEb1 of the second pixel electrode PEb, and the liquid crystal layer is disposed between the first subpixel electrode PEa1 of the first pixel electrode PEa and the third subpixel electrode PEb1 of the second pixel electrode PEb as an insulating layer. The second liquid crystal capacitor Clcb is connected to the second subpixel electrode PEa2 of the first pixel electrode PEa and the fourth subpixel electrode PEb2 of the second pixel electrode PEb, and the liquid crystal layer is disposed between the second subpixel electrode PEa2 of the first pixel electrode PEa and the fourth subpixel electrode PEb2 of the second pixel electrode PEb as an insulating layer.

The step-down capacitor CS is connected to the output terminal of the fifth switching element Qc and the capacitor voltage line CL, and the step-down capacitor CS may be provided by overlapping the capacitor voltage line CL on the lower panel 100 and the output electrode of the fifth switching element Qc with an insulator therebetween.

Hereinafter, an exemplary embodiment of a driving method of the liquid crystal display will now be described.

Referring to FIGS. 1, 4, and 5, the signal controller 600 receives input image signals R, G and B and input control signals, which control a display of the liquid crystal display, from an external device, e.g., a graphic controller (not shown). The input image signals R, G and B have luminance information of each pixel PX, and the luminance has a predetermined number of gray levels, for example, gray levels of 1024 (=2¹⁰), 256 (=2⁸), or 64 (=2⁶). In an exemplary embodiment, the input control signal includes a vertical synchronization signal Vsyn, a horizontal synchronizing signal Hsync, a main clock signal MCLK and a data enable signal DE, for example.

The signal controller 600 processes the input image signals R, G and B in accordance with an operating condition of the liquid crystal panel assembly 300 based on the input image signals R, G and B and the input control signals. In such an embodiment, the signal controller 600 generates a gate control signal CONT1, a data control signal CONT2, for example, then transmits the gate control signal CONT1 to the gate driver 400, and transmits the data control signal CONT2 and a processed output image signal DAT to the data driver 500. The output image signal DAT is a digital signal having a value or a gray corresponding to one of the predetermined number of gray levels. In an exemplary embodiment, the data driver 500 receives the digital output image signal DAT for the pixels PX of one pixel row based on the data control signal CONT2 from the signal controller 600, and selects gray voltage corresponding to the value of the digital image signal DAT such that the data driver 500 converts the digital image signal DAT to an analog data voltage and then applies the converted analog data voltage to a data line Dj.

In an exemplary embodiment, the gate driver 400 applies a gate-on voltage Von to the gate line Gi and the auxiliary gate line Gs based on the gate control signal CONT1 from the signal controller 600 to turn on the switching elements Qa1, Qa2, Qb1, Qb2 and Qc, which are connected thereto. In such an embodiment, a voltage VC having a constant magnitude applied to the voltage transfer line C1 and data voltage Vd applied to the data line Dj are applied to the pixel electrodes PEa1, PEa2, PEb1 and PEb2 of the corresponding pixel PX through the turned-on switching elements Qa1, Qa2, Qb1 and Qb2.

Hereinafter, an exemplary embodiment of the driving method of the liquid crystal display will be described in accordance with a predetermined pixel row. The first gate signal is applied to the gate line Gi of an i-th row and the second gate signal is applied to the auxiliary gate line Gs. When the first gate signal is changed from the gate-off voltage to the gate-on voltage, the first switching element Qa1, the second switching element Qa2, the third switching element Qb1 and the fourth switching element Qb2, which are connected to the gate line Gi, are turned on. In an exemplary embodiment, a first voltage Vch having a predetermined magnitude applied to the voltage transfer line C1 are applied to the first subpixel electrode PEa1 and the second subpixel electrode PEa2 of the first pixel electrode PEa through the turned-on first switching element Qa1 and second switching element Qa2, and the data voltages Vd applied to the data line Dj are applied to the third subpixel electrode PEb1 and the fourth subpixel electrode PEb2 of the second pixel electrode PEb through the turned-on third switching element Qb1 and fourth switching element Qb2. In such an embodiment, the first voltage Vch applied to the first subpixel electrode PEa1 and the second subpixel electrode PEa2 of the first pixel electrode PEa are substantially the same as each other, and magnitudes of the data voltages Vd applied to the third subpixel electrode PEb1 and the fourth subpixel electrode PEb2 of the second pixel electrode PEb are substantially the same as each other. Accordingly, the first and second liquid crystal capacitors Clca and Clcb are charged by substantially the same value corresponding to a difference between the first voltage Vch and the data voltage Vd.

In an exemplary embodiment, when the first gate signal is changed from the gate-on voltage to the gate-off voltage and the second gate signal is changed from the gate-off voltage to the gate-on voltage, the first switching element Qa1, the second switching element Qa2, the third switching element Qb1 and the fourth switching element Qb2 are turned off, and the fifth switching element Qc is turned on. As a result, charges move from the second subpixel electrode PEa2 of the first pixel electrode PEa through the fifth switching element Qc. Then, the charged voltage of the second liquid crystal capacitor Clcb decreases by capacitance of the step-down capacitor Cd such that the charged voltage of the second liquid crystal capacitor Clcb becomes lower than the charged voltage of the first liquid crystal capacitor Clca. In such an embodiment, a magnitude of the voltage Vcl applied to the second subpixel electrode PEa2 becomes less than a magnitude of the first voltage Vch applied to the first subpixel electrode PEaa. Accordingly, a voltage difference ΔVl between the second subpixel electrode PEa2 and the fourth subpixel electrode PEb2 becomes less than a voltage difference ΔVh between the first subpixel electrode PEa1 and the third subpixel electrode PEb1.

In such an embodiment, as shown in FIG. 6, the charged voltages of the liquid crystal capacitors Clca and Clcb have different gamma curves in a first region Rh defined by the first subpixel electrode PEa1 of the first pixel electrode PEa and the third subpixel electrode PEb1 of the second pixel electrode PEb and a second region RD defined by the second subpixel electrode PEa2 of the first pixel electrode PEa and the fourth subpixel electrode PEb2 of the second pixel electrode PEb, and the gamma curve of one pixel voltage is a curve synthesizing the different gamma curves. In an exemplary embodiment, the synthesized gamma curve in the front may be controlled to be substantially identical to a reference gamma curve in the front determined and the synthesized gamma curve in the side may be controlled to be substantially close or similar to the reference gamma curve in the front. In such an embodiment, side visibility may be substantially improved by converting the image data.

In an exemplary embodiment, the above-described process may be repeated by a unit of horizontal period (also, referred to as “1 H” and the same as one cycle of the horizontal synchronizing signal Hsync and the data enable signal DE) such that images of one frame are displayed by applying the data voltage Vd to all the pixels PX.

When a frame ends and a subsequent frame starts, a state of an inversion signal RVS applied to the data driver 500 is controlled such that the polarity of the data voltage Vd applied to each pixel PX in the subsequent frame is opposite to the polarity of the data voltage Vd applied to each pixel PX in the frame, and such that the polarity of the first voltage Vch applied to the voltage transfer line in the subsequent frame is opposite to the polarity of the first voltage Vch applied to the voltage transfer line in the frame.

In an exemplary embodiment, the first voltage having a predetermined magnitude and the data voltage having a predetermined magnitude are applied to one pixel PX to generate the electric field in the liquid crystal layer, the magnitude of the driving voltage and the response speed of the liquid crystal molecule substantially increase, and transmittance of the liquid crystal display is thereby substantially improved. In such an embodiment, when the switching element in one pixel is turned off, all the voltages applied to the first and second pixel electrodes PEa and PEb, which generate the electric field in the liquid crystal layer, drop down by a kickback voltage thereof such that the charged voltage of the pixel PX is not substantially changed. Accordingly, display characteristics of the liquid crystal display are substantially improved.

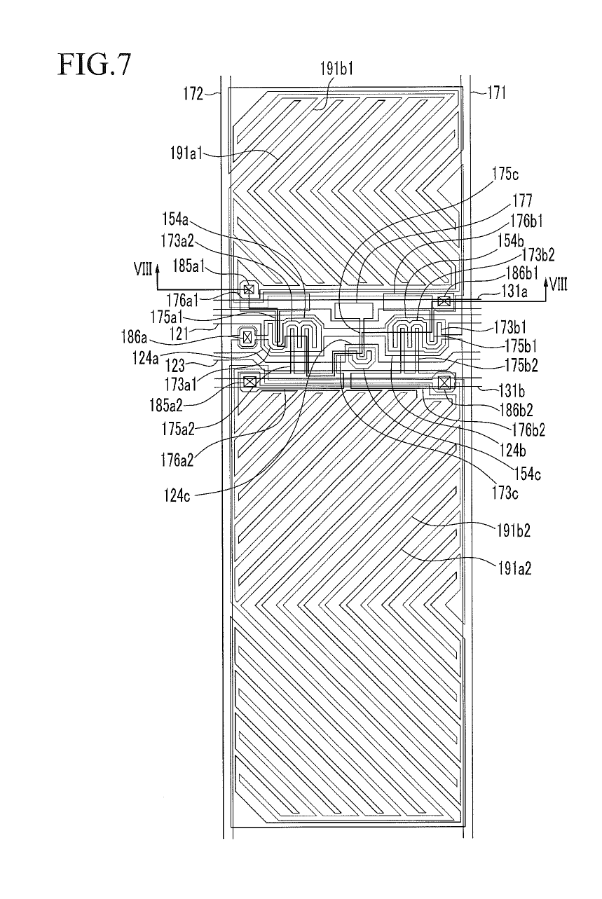

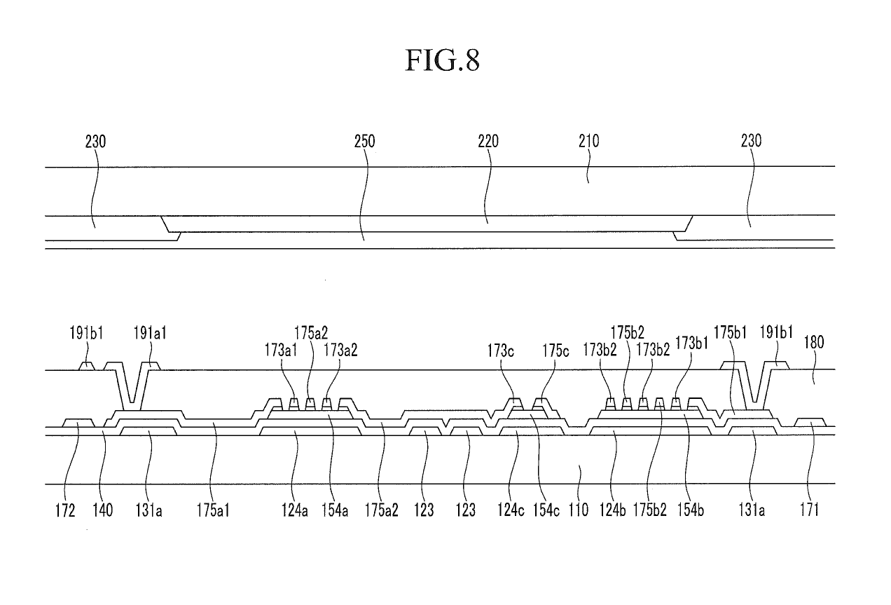

In an exemplary embodiment, one pixel PX area may be divided into two regions Rh and Rl having different luminances when a same data voltage is applied, such that an image viewed from the side may be substantially close to an image viewed from the front, the side visibility is thereby substantially improved, and the transmittance is thereby substantially increases. Hereinafter, an exemplary embodiment of the liquid crystal display shown in FIG. 4 will be described in detail with reference to FIGS. 7 and 8. FIG. 7 is a top plan view of an exemplary embodiment of the liquid crystal display shown in FIG. 4, and FIG. 8 is a cross-sectional view of the liquid crystal display of FIG. 7 taken along line VIII-VIII.

Referring to FIGS. 7 and 8, an exemplary embodiment of the liquid crystal display according to the invention includes a lower panel 100 and an upper panel 200 disposed opposite to, e.g., facing, each other, and a liquid crystal layer 3 interposed between the lower and upper panels 100 and 200.

Hereinafter, the lower panel 100 will be described.

The lower panel 100 includes an insulation substrate 110. The lower panel 100 further includes gate conductors including a plurality of gate lines 121, a plurality of auxiliary gate lines 123, and a plurality of capacitor voltage lines 131a and 131b provided on the insulation substrate 110.

The gate lines 121 transfer gate signals and extend substantially in a horizontal direction, and each of the gate lines 121 includes a first protruding gate electrode 124a and a second protruding gate electrode 124b. The auxiliary gate lines 123 transfer gate signals and extend substantially parallel to the gate lines 121 and each of the auxiliary gate lines 123 includes a third protruding gate electrode 124c.

The capacitor voltage lines 131a and 131b receive predetermined voltages and extend substantially in the horizontal direction. The capacitor voltage lines 131a and 131b include a plurality of capacitor electrodes and storage electrodes which are expanded portion thereof.

The gate conductor may have a single layered or multilayered structure.

In an exemplary embodiment, the lower panel 100 further includes a gate insulating layer 140 provided on the gate conductor. The gate insulating layer 140 may include silicon nitride (SiNx) or silicon oxide (SiOx), for example.

The lower panel 100 further includes a first semiconductor 154a, a second semiconductor 154b and a third semiconductor 154c provided on the gate insulating layer 140. The first semiconductor 154a, the second semiconductor 154b and the third semiconductor 154c may include hydrogenated amorphous or polycrystalline silicon, for example.

As shown in FIG. 8, a pair of ohmic contacts is provided on each of the first, second and third semiconductor 154a, 154b or 154c. The ohmic contact may include a material such as n+ hydrogenated amorphous silicon doped with an n-type impurity such as phosphorus at a high concentration or silicide. In an alternative exemplary embodiment of the liquid crystal display according to the invention, the ohmic contact may be omitted. In an exemplary embodiment, where each semiconductor 154a, 154b or 154c includes an oxide semiconductor, the ohmic contact may be omitted.

The lower panel further includes a voltage transfer line 172, a data line 171 and a data conductor including a first drain electrode 175a1, a second drain electrode 175a2, a third drain electrode 175b1, a fourth drain electrode 175b2 and a fifth drain electrode 175c provided on the ohmic contact and the gate insulating layer 140.

The data line 171 transfers a data signal and extends substantially in a vertical direction crossing the gate line 121 and the capacitor voltage lines 131a and 131b. The voltage transfer line 172 transfers the voltage having a constant magnitude and extends substantially parallel to the data line 171 crossing the gate line 121 and the capacitor voltage lines 131a and 131b.

The voltage transfer line 172 includes a first source electrode 173a1 and a second source electrode 173a2 extending toward the first gate electrode 124a.

The data line 171 includes a third source electrode 173b1 and a fourth source electrode 173b2 extending toward the second gate electrode 124b.

In an exemplary embodiment, the voltage transferred by the voltage transfer line 172 may have a predetermined magnitude and has a polarity changed per frame. In an exemplary embodiment, the voltage transfer line 172 may be connected to three adjacent pixel columns to transfer the same voltage.

The first drain electrode 175a1 includes a rod-shaped end portion and a first extension portion 176a1 having a wide area, and the second drain electrode 175a2 includes a rod-shaped end portion and a second extension portion 176a2 having a wide area. The third drain electrode 175b1 includes a rod-shaped end portion and a third extension portion 176b1 having a wide area, and the fourth drain electrode 175b2 includes a rod-shaped end portion and a fourth extension portion 176b2 having a wide area.

The rod-shaped end portion of the first drain electrode 175a1 and the rod-shaped end portion of the second drain electrode 175a2 are opposite to the first source electrode 173a1 and the second source electrode 173a2 based on the first gate electrode 124a, and the rod-shaped end portions are partially surrounded by bent portions of the first source electrode 173a1 and the second source electrode 173a2. The first and second extension portions 176a1 and 176a2 having the wide areas are electrically connected with the first subpixel electrode 191a1 and the second subpixel electrode 191a2 of the first pixel electrode 191a through a first contact hole 185a1 and a second contact hole 185a2 and overlapping the storage electrode of the capacitor voltage lines 131a and 131b.

The rod-shaped end portion of the third drain electrode 175b1 and the rod-shaped end portion of the fourth drain electrode 175b2 are opposite to the third source electrode 173b1 and the fourth source electrode 173b2 based on the second gate electrode 124b, and the rod-shaped end portions are partially surrounded by bent portions of the third source electrode 173b1 and the fourth source electrode 173b2. The third and fourth extension portions 176b1 and 176b2 having the wide areas are electrically connected with the third subpixel electrode 191b1 and the fourth subpixel electrode 191b2 of the second pixel electrode 191b through a third contact hole 186b1 and a fourth contact hole 186b2 and overlapping the storage electrode of the capacitor voltage lines 131a and 131b.

The second extension portion 176a2 of the second drain electrode 175a2 is connected with a fifth source electrode 173c, and the fifth drain electrode 175c includes a rod-shaped end portion and an extended fifth extension portion 177. The fifth drain electrode 175c is opposite to the fifth source electrode 173c on the third gate electrode 124c and is partially surrounded by the fifth source electrode 173c. The fifth extension portion 177 having a wide area overlaps the capacitor electrode of the capacitor voltage line 131a.

The first gate electrode 124a, the first source electrode 173a1 and the first drain electrode 175a1 collectively define a first thin film transistor (“TFT”) Qa1 together with a first semiconductor island 154a, such that a channel of the first TFT is formed in the semiconductor 154a between the source electrode 173a1 and the drain electrode 175a1. The first gate electrode 124a, the second source electrode 173a2 and the second drain electrode 175a2 collectively define a second TFT Qa2 together with the first semiconductor island 154a such that a channel of the second TFT is formed in the semiconductor 154a between the source electrode 173a2 and the drain electrode 175a2.

The second gate electrode 124b, the third source electrode 173b1 and the third drain electrode 175b1 collectively define a third TFT Qb1 together with the second semiconductor island 154b, the second gate electrode 124b, the fourth source electrode 173b2 and the fourth drain electrode 175b2 collectively define a fourth TFT Qb2 together with the second semiconductor island 154b, and the third gate electrode 124c, the fifth source electrode 173c and the fifth drain electrode 175c collectively defines a fifth TFT Qc together with the third semiconductor island 154c.

The lower panel 100 further includes a passivation layer 180 provided on the data conductor 171, 172, 173c, 175a1, 175a2, 175b1, 175b2 and 175c and the exposed portions of the semiconductors 154a, 154b, and 154c.

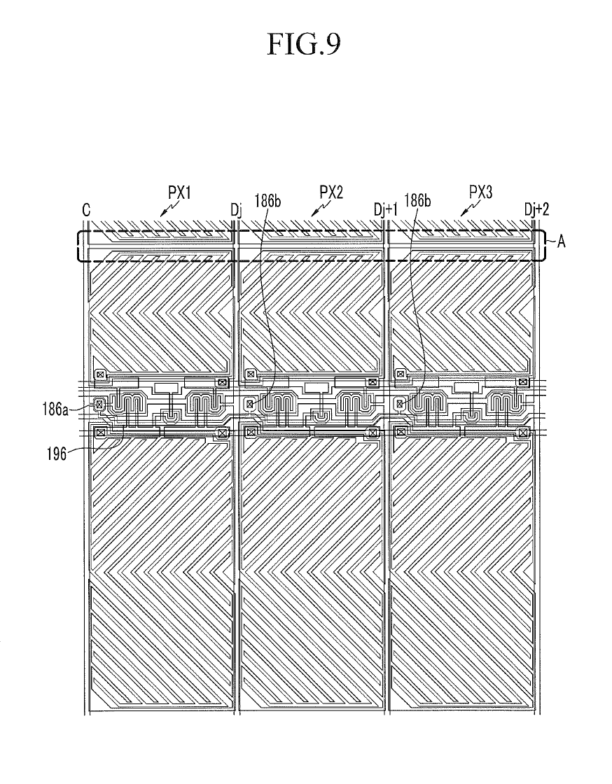

The lower panel 100 further includes a first contact hole 185a1 exposing the first extension portion 176a1 of the first drain electrode 175a1, a second contact hole 185a2 exposing the second extension portion 176a2 of the second drain electrode 175a2, a third contact hole 185b1 exposing the third extension portion 176b1 of the third drain electrode 175b1 and a fourth contact hole 185b2 exposing the fourth extension portion 176b2 of the fourth drain electrode 175b2, which are provided on the passivation layer 180. In an exemplary embodiment, a fifth contact hole 186a partially exposing the voltage transfer line 172, the first source electrode 173a1 and the second source electrode 173a2 may be formed on the passivation layer 180. The fifth contact hole 186a is in connect with a connection member (not shown) for transferring the voltage transferred by the voltage transfer line 172 to an adjacent pixel and the voltage transfer line 172, which will be described later in greater detail with reference to FIG. 9.

The lower panel includes pixel electrodes including a first pixel electrode 191a and a second pixel electrode 191b provided on the passivation layer 180. The first pixel electrode 191a includes a first subpixel electrode 191a1 and a second subpixel electrode 191a2, and the second pixel electrode 191b includes a third subpixel electrode 191b1 and a fourth subpixel electrode 191b2.

Each of the subpixel electrodes 191a1, 191a2, 191b1 and 191b2 has a stem extending along an edge of a pixel area and a plurality of branches protruding from the stem. In an exemplary embodiment, the branches of the first subpixel electrode 191a1 and the branches of the third subpixel electrode 191b1 are engaged with each other at a predetermined interval and alternately disposed to form the first region of the pixel area. In an exemplary embodiment, the branch of the second subpixel electrode 191a2 and the branch of the fourth subpixel electrode 191b2 are engaged with each other with a predetermined interval and alternately disposed to form the first region of the pixel area.

In one exemplary embodiment, for example, a distance between the respective branches is less than about 30 micrometers (μm). In an alternative exemplary embodiment, although not shown, at least one of the first region and the second region of the pixel area may include a portion having a relatively large distance between the adjacent branches and a portion having a relatively small distance between the adjacent branches. The gray may be variously displayed based on the distance between the adjacent branches. In an exemplary embodiment, in a region where the distance between the branches of the first and second pixel electrodes 191a and 191b, which are alternately disposed each other, is relative large, intensity of the electric field applied to the liquid crystal layer 3 between the branches in the region decreases, such that the relatively low gray is displayed although the same voltage is applied, as compared with the intensity of the electric filed applied to the liquid crystal layer 3 between the braches in a region having the small distance. In an exemplary embodiment, when the distance between the branches of first and second pixel electrodes 191a and 191b, which are alternately disposed each other, has a small region, intensity of the electric field applied to the liquid crystal layer 3 between the branches increases, such that the relatively high gray is displayed although the same voltage is applied, as compared with the intensity of the electric filed applied to the liquid crystal layer 3 between the braches in a region having the large distance. In an exemplary embodiment, the distance between the branches of the first pixel electrode 191a and the second pixel electrode 191 b is substantially diversified, such that the inclined angle of the liquid crystal molecules 31 of the liquid crystal layer 3 may be substantially diversified, and different luminances for same image information may be displayed.

As shown in FIG. 7, the first pixel electrode 191a and the second pixel electrode 191b are planar, and the branches of the first pixel electrode 191a and the second pixel electrode 191b are bent from the stems at a predetermined angle with the gate line 121. In an alternative exemplary embodiment of the liquid crystal display according to the invention, the data line 171 and the voltage transfer line 172 may also have a planar form bent substantially in parallel to the branches of the first pixel electrode 191a and the second pixel electrode 191b.

However, the shapes of the first pixel electrode 191a and the second pixel electrode 191b of one pixel of the liquid crystal display are not limited thereto. In an exemplary embodiment, the first pixel electrode 191a and the second pixel electrode 191b may have a shape where at least a portion of the first pixel electrode 191a and a portion of the second pixel electrode 191b are on the same layer and are alternately disposed each other.

In an exemplary embodiment, the first subpixel electrode 191a1 of the first pixel electrode 191a is physically and electrically connected with the first drain electrode 175a1 through the first contact hole 185a1, and the second subpixel electrode 191a2 of the first pixel electrode 191a is physically and electrically connected with the second drain electrode 175a2 through the second contact hole 185a2, thereby receiving the voltage transferred through the voltage transfer line 172. In an exemplary embodiment, the third subpixel electrode 191b1 of the second pixel electrode 191b is physically and electrically connected with the third drain electrode 175b1 through the third contact hole 185b1, and the fourth subpixel electrode 191b2 of the second pixel electrode 191b is physically and electrically connected with the fourth drain electrode 175b2 through the fourth contact hole 185b2, thereby receiving the data voltage flowing in the data line 171.

The extension portions 176a1, 176a2, 176b1 and 176b2 of the drain electrodes 175a1, 175a2, 175b1 and 175b2, which are connected with the first pixel electrode 191a and the second pixel electrode 191b, define the storage capacitor by overlapping the storage electrode with the gate insulating layer 140 interposed therebetween, and the storage capacitor reinforces voltage storage ability of the liquid crystal capacitors Clca and Clcb.

The capacitor electrode of the capacitor voltage line 131a and the fifth extension portion 177 of the fifth drain electrode 175c are overlapping h each other with the gate insulating layer 140 interposed therebetween such that the step-down capacitor CS. In an exemplary embodiment, the step-down capacitor CS is provided by the gate conductor and the data conductor, and an additional process for providing the step-down capacitor CS is thereby omitted such that the manufacturing process of the liquid crystal display is substantially simplified. In such an embodiment, only the gate insulating layer 140 is disposed between two electrodes of the step-down capacitor CS, such that the capacitance of the step-down capacitor CS may increase as compared with an embodiment where other insulating layers are disposed between two electrodes.

A lower alignment layer (not shown) may be provided, e.g., coated, on the inner surface of the lower panel 100, and the lower alignment layer may be a vertical alignment layer. Although not shown, a polymer layer may be provided on the lower alignment layer, and the polymer layer may include a polymer branch disposed along an initial alignment direction of the liquid crystal molecule 31. In an exemplary embodiment, the polymer layer may be formed by light-exposing and polymerizing a prepolymer of a monomer, for example, cured by polymerization due to light, e.g., ultraviolet rays, and may control an alignment force of the liquid crystal molecule based on the polymer branch.

Hereinafter, the upper panel 200 will be described.

The upper panel 200 includes an insulation substrate 210 including transparent glass or plastic, for example. The upper panel 200 includes a light blocking member 220 disposed on the insulation substrate 210. The light blocking member 220 effectively prevents light leakage between the pixel electrodes and defines an opening region facing the pixel electrode 191.

The upper panel 200 includes a plurality of color filters 230 on the insulation substrate 210 and the light blocking member 220. The color filters 230 is disposed substantially in a region surrounded by the light blocking member 220 and may be elongated along a pixel column. Each of the color filters 230 may display one of three primary colors of red, green and blue, or one of the primary colors of yellow, cyan and magnate, for example, but not being limited thereto. In an exemplary embodiment, each pixel may further display a mixed color of the primary colors or white other than the primary colors.

In an alternative exemplary embodiment, at least one of the light blocking member 220 and the color filter 230 may be provided on the lower panel 100.

The upper panel 200 includes an overcoat 250 disposed on the color filter 230 and the light blocking member 220. The overcoat 250 may include (organic) insulator, effectively prevents the color filter 230 from being exposed and provides a flat surface. In an alternative exemplary embodiment, the overcoat 250 may be omitted.

An upper alignment layer (not shown) may be provided, e.g., coated, on the inner surface of the upper panel 200, and the upper alignment layer may be a vertical alignment layer. In an exemplary embodiment, although not shown, a polymer layer may be provided on the upper alignment layer. In an exemplary embodiment, the polymer layer may be formed by light-exposing a prepolymer of a monomer cured by polymerization due to the light, e.g., ultraviolet rays, and may control an alignment force of the liquid crystal molecule. The polymer layer may include a polymer branch formed along an initial alignment direction of the liquid crystal molecule.

In an exemplar embodiment, polarizers (not shown) may be provided on the outer surfaces of the lower and upper panels 100 and 200.

The liquid crystal layer 3 interposed between the lower panel 100 and the upper panel 200 includes liquid crystal molecules 31 having positive dielectric anisotropy, and a longitudinal axis of the liquid crystal molecules 31 may be aligned substantially perpendicular to the surfaces of the lower and upper panels 100 and 200 when the electric field is not generated therein.

When voltages having different magnitudes are applied to the first pixel electrode 191a and the second pixel electrode 191b, the electric field substantially horizontal to the surfaces of the lower and upper panels 100 and 200 is generated. Then, the liquid crystal molecules of the liquid crystal layer 3, which is initially vertically aligned with respect to the surfaces of the lower and upper panels 100 and 200, respond to the electric field, the longitudinal axes of the liquid crystal molecules are inclined in a direction substantially parallel to the electric field direction, and a degree of variation in the polarization of the incident light in the liquid crystal layer 3 varies according to the inclined degree of the liquid crystal molecule. The variation in the polarization causes variation in transmittance due to the polarizer, thereby displaying the image in the liquid crystal display.

In an exemplary embodiment, when the vertically aligned liquid crystal molecules 31 are used, a contrast ratio of the liquid crystal display may increase and the viewing angel may be substantially increased. In such an embodiment, when the vertically aligned liquid crystal molecules 31 with respect to the lower and upper panels 100 and 200 are used, a contrast ratio of the liquid crystal display may increase and the wide viewing angel may be implemented. In an exemplary embodiment, the liquid crystal molecules 31 having positive dielectric anisotropy may be used to increase response speed thereof since the liquid crystal molecules having positive dielectric anisotropy have greater dielectric anisotropy and lower rotation viscosity than the liquid crystal molecules having negative dielectric anisotropy.

In an exemplary embodiment of the liquid crystal display, the branches of the first pixel electrode 191a and the second pixel electrode 191b in a comb pattern are engaged with each other and alternately disposed. The first subpixel electrode 191a1 of the first pixel electrode 191a and the third subpixel electrode 191b1 of the second pixel electrode 191b are disposed in a first region, and the second subpixel electrode 191a2 of the second pixel electrode 191a and the fourth subpixel electrode 191b2 of the second pixel electrode 191b are disposed in a second region. In an exemplary embodiment, some of the charges charged in the second subpixel electrode 191a2 of the second region move from the fifth source electrode 173c to the fifth drain electrode 175c, such that the intensity of the electric field of the second liquid crystal capacitor Clcb of the second region is less than the intensity of the first liquid crystal capacitor Clca of the first region. Accordingly, gamma curves of the charged voltages of the first and second liquid crystal capacitors Clca and Clcb are different from each other, and the gamma curve of one pixel voltage becomes a synthesized curve of the gamma curves of the charged voltages of the first and second liquid crystal capacitors Clca and Clcb. In an exemplary embodiment, the synthesized gamma curve in the front may be controlled to be substantially identical to a reference gamma curve in the front, and the synthesized gamma curve in the side may be controlled to be substantially close or similar to the reference gamma curve in the front. In such an embodiment, the side visibility of the liquid crystal display is substantially improved.

Hereinafter, other features of the exemplary embodiment of the liquid crystal display will be described with reference to FIG. 9. FIG. 9 is a top plan view of the liquid crystal display shown in FIGS. 7 and 8, showing a plurality of pixels thereof.

Referring to FIG. 9, the voltage transfer line 172 of the liquid crystal display is connected with the first source electrodes 173a1 of three adjacent pixel columns in a pixel row direction by a connection part 196. The first source electrode 173a1 of each the three adjacent pixels is connected with the connection part 196 through the contact holes 186a, 186b and 186c. The connection part 196 may be disposed in a layer in which the pixel electrode is disposed.

Referring to FIG. 9, the first pixel electrodes 191a of two adjacent pixels in the pixel column direction are disposed opposite to each other, and receive the voltage having a constant magnitude from the voltage transfer line 172. Accordingly, signal interference between the two adjacent pixels in the pixel column direction may not occur such that deterioration in image quality due to the signal interference is effectively prevented.

Referring to FIG. 9, the first pixel electrodes 191a of two adjacent pixels are disposed opposite to each other with respect to a data line disposed therebetween, the second pixel electrodes 191b of the two adjacent pixels are disposed opposite to each other based on the data line, and lengths of the facing branches are substantially the same as each other. Accordingly, a difference in parasite capacitances between the data line and the pixel electrode may be substantially reduced, and the deterioration in image quality due to the difference in parasite capacitances may be effectively prevented.

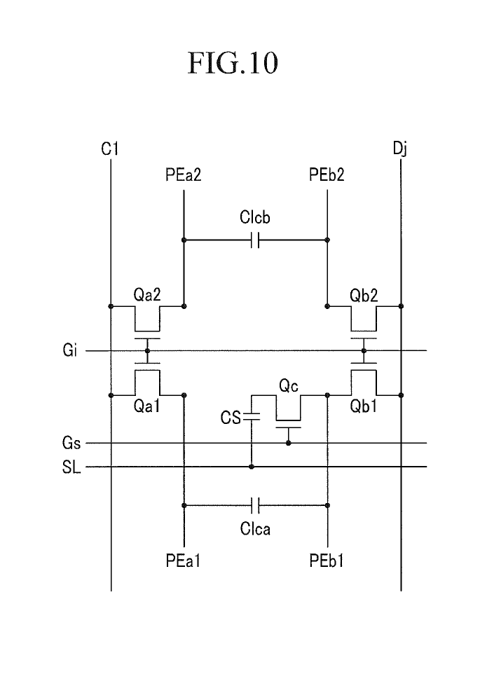

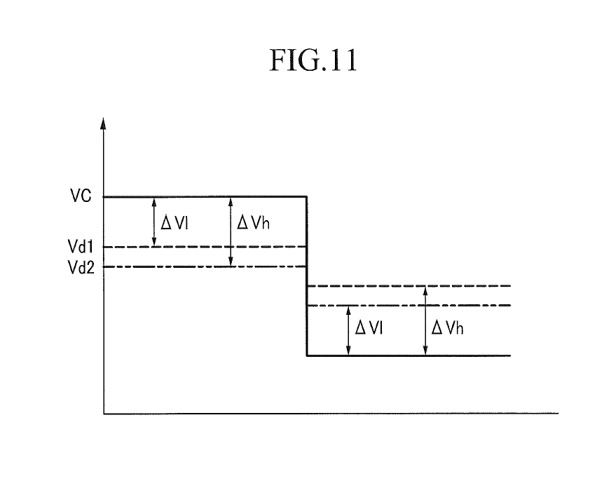

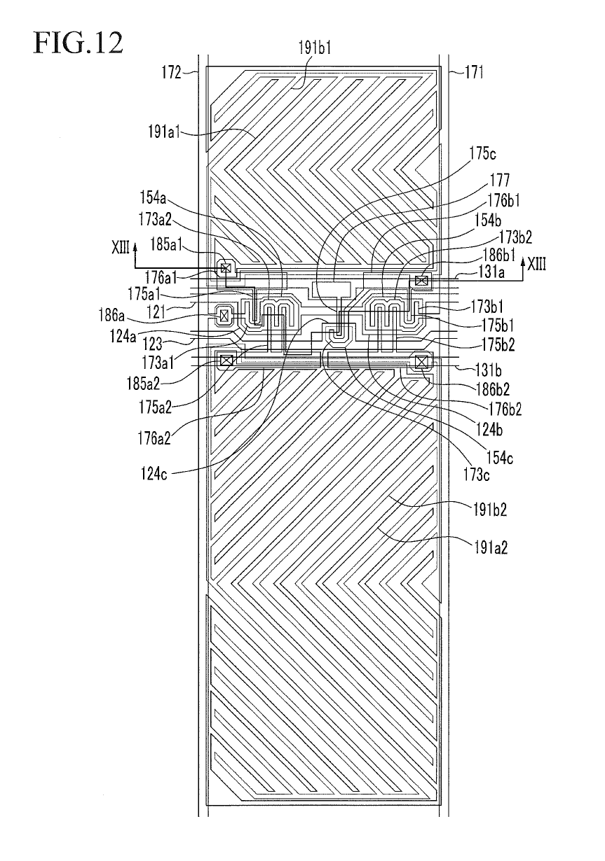

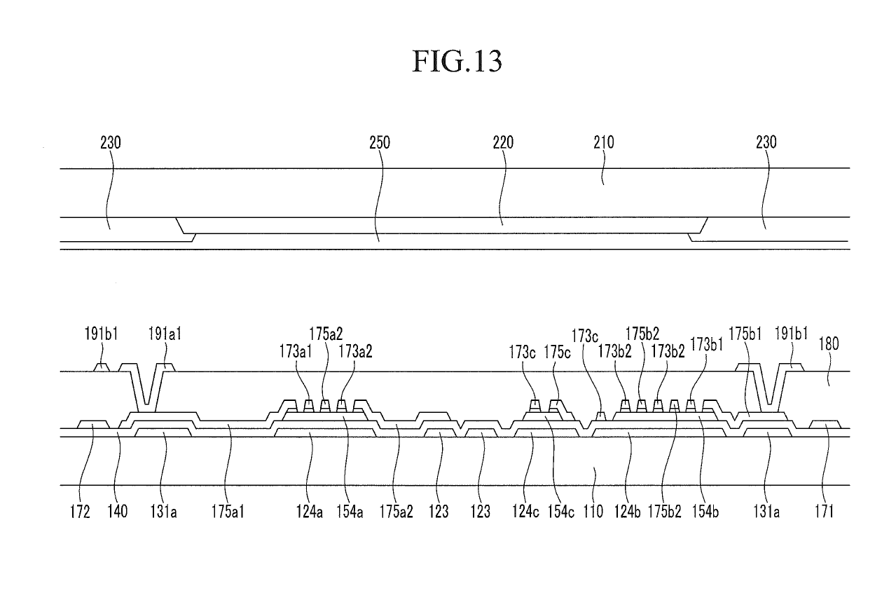

Hereinafter, an alternative exemplary embodiment of the liquid crystal display according the invention will now be described with reference to FIGS. 10 to 13. FIG. 10 is an equivalent circuit diagram of one pixel of an alternative exemplary embodiment of a liquid crystal display according to the invention, FIG. 11 is a waveform diagram of a signal applied to a pixel of the liquid crystal display shown in FIG. 10, FIG. 12 is a top plan view of the liquid crystal display shown in FIG. 10, and FIG. 13 is a cross-sectional view of the liquid crystal display of FIG. 12 taken along line XIII-XIII.

The liquid crystal display shown in FIGS. 10 to 13 is similar to the liquid crystal display shown in FIGS. 4, 7 and 8. The same or like elements shown in FIGS. 10 to 13 have been labeled with the same reference characters as used above to describe the exemplary embodiments of the liquid crystal display shown in FIGS. 4, 7 and 8, and any repetitive detailed description thereof will hereinafter be omitted or simplified.

Referring to FIG. 10, in an exemplary embodiment of the liquid crystal display, an input terminal of the fifth TFT Qc is not connected to an output terminal of the second switching element Qa2 connected to the second subpixel electrode PEa2 of the first pixel electrode PEa, but connected to an output terminal of the third switching element Qb1 connected to the third subpixel electrode PEb1 of the second pixel electrode PEb. Accordingly, the data voltages transferred through the data line Dj are charged by the same magnitude in the third subpixel electrode PEb1 and the fourth subpixel electrode PEb2 of the second pixel electrode PEb and then, some of the charges of the second subpixel electrode PEb1 move to the step-down capacitor CS through the fifth switching element Qc.

Accordingly, the charged voltage of the first liquid crystal capacitor Clca between the third subpixel electrode PEb1 and the first subpixel electrode PEa1 becomes higher than the charged voltage of the second liquid crystal capacitor Clcb between the fourth subpixel electrode PEb2 and the second subpixel electrode PEa2.

The charged voltages of the first and second liquid crystal capacitor Clca and Clcb will be described with reference to FIG. 11.

The first gate signal is applied to the gate line Gi of the i-th row, and the second gate signal is applied to the auxiliary gate line Gs. When the first gate signal is changed from the gate-off voltage to the gate-on voltage, the first switching element Qa1, the second switching element Qa2, the third switching element Qb1 and the fourth switching element Qb2, which are connected to the gate line Gi, are turned on. Accordingly, a third voltage VC having a predetermined magnitude applied to the voltage transfer line C1 is applied to the first subpixel electrode PEa1 and the second subpixel electrode PEa2 of the first pixel electrode PEa through the turned-on first switching element Qa1 and second switching element Qa2, and a first data voltage Vd1 applied to the data line Dj is applied to the third subpixel electrode PEb1 and the fourth subpixel electrode PEb2 of the second pixel electrode PEb through the turned-on third switching element Qb1 and fourth switching element Qb2. In such an embodiment, magnitudes of the third voltages VC applied to the first subpixel electrode PEa1 and the second subpixel electrode PEa2 of the first pixel electrode PEa are substantially the same as each other, and magnitudes of the first data voltages Vd1 applied to the third subpixel electrode PEb1 and the fourth subpixel electrode PEb2 of the second pixel electrode PEb are substantially the same as each other. Accordingly, the first and second liquid crystal capacitors Clca and Clcb are charged by the same value corresponding to a difference between the third voltage VC and the first data voltage Vd1.

When the first gate signal is changed from the gate-on voltage to the gate-off voltage and the second gate signal is changed from the gate-off voltage to the gate-on voltage, the first switching element Qa1, the second switching element Qa2, the third switching element Qb1 and the fourth switching element Qb2 are turned off, and the fifth switching element Qc is turned on. Then, the charges move from the first subpixel electrode PEa1 of the first pixel electrode PEa through the fifth switching element Qc, and the first data voltage Vd1 charged in the first subpixel electrode PEa1 of the first pixel electrode PEa is lowered to the second data voltage Vd2 by the capacitance of the step-down capacitor Cd. Accordingly, the charged voltage of the first liquid crystal capacitor Clca becomes greater than the charged voltage of the second liquid crystal capacitor Clcb. In such an embodiment, a magnitude of the voltage Vd2 applied to the first subpixel electrode PEa1 is less than a magnitude of the voltage Vd1 applied to the second subpixel electrode PEa2. Accordingly, a voltage difference ΔVh between the first subpixel electrode PEa1 and the third subpixel electrode PEb1 is greater than a voltage difference ΔVl between the second subpixel electrode PEa2 and the fourth subpixel electrode PEb2, such that the charged voltage of the first liquid crystal capacitor Clca is greater than the charged voltage of the second liquid crystal capacitor Clcb.

In an exemplary embodiment, the charged voltages of the liquid crystal capacitors Clca and Clcb have different gamma curves in a region defined by the first subpixel electrode PEa1 of the first pixel electrode PEa and the third subpixel electrode PEb1 of the second pixel electrode PEb and in a region defined by the second subpixel electrode PEa2 of the first pixel electrode PEa and the fourth subpixel electrode PEb2 of the second pixel electrode PEb, and the gamma curve of one pixel voltage is a curve acquired by synthesizing the different gamma curves. The synthesized gamma curve in the front is controlled to be substantially identical to a reference gamma curve in the front determined, and the synthesized gamma curve in the side is controlled to be substantially close or similar to the reference gamma curve in the front. In such an embodiment, side visibility is substantially improved by converting the image data.

Referring to FIGS. 12 and 13, the fifth source electrode 173c is not connected to the second extension portion 176a2 of the second drain electrode 175a2, but connected to the third extension portion 176b1 of the third drain electrode 175b1.

In an exemplary embodiment, an area of a region occupied by the first liquid crystal capacitor Clca, that is, the region defined by the first subpixel electrode PEa1 of the first pixel electrode PEa and the third subpixel electrode PEb1 of the second pixel electrode PEb, is less than an area of a region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively large region is substantially uniformly maintained, and the charged voltage of the first liquid crystal capacitor Clca occupying the relatively small region increases, such that gamma curves of the charged voltages of the first and second liquid crystal capacitors Clca and Clcb become different. In such an embodiment, an increase of luminance in low gray may be substantially related to the charged voltage of the first liquid crystal capacitor Clca having the relatively small area and the relatively high charged voltage. In such an embodiment, when an image of low gray is displayed, the transmittance in the side may be effectively prevented from substantially being increased as compared with the transmittance in the front such that distortion in visibility may be substantially reduced or effectively prevented.

In an alternative exemplary embodiment of the liquid crystal display according to the invention, the area of the region occupied by the first liquid crystal capacitor Clca, that is, the region defined by the first subpixel electrode PEa1 of the first pixel electrode PEa and the third subpixel electrode PEb1 of the second pixel electrode PEb may be greater than the area of the region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively small region is substantially uniformly maintained, and the charged voltage of the first liquid crystal capacitor Clca occupying the relatively large region increases, such that gamma curves of the charged voltages of the first and second liquid crystal capacitors Clca and Clcb become different. In such an embodiment, luminance in high gray may be determined based on the charged voltages of the first liquid crystal capacitor Clca and the second liquid crystal capacitor Clcb, and the entire luminance of the liquid crystal display may increase due to the relatively large area of the first liquid crystal capacitor Clca.

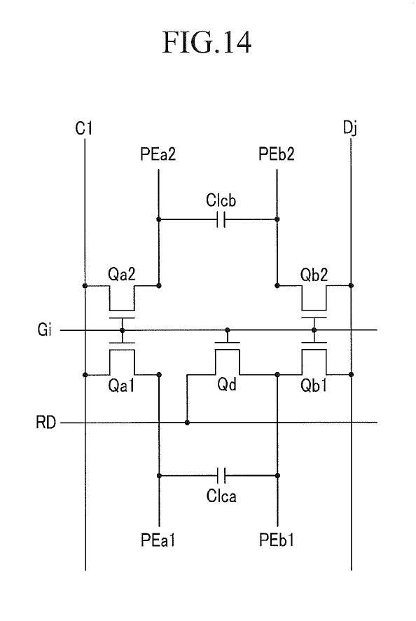

The illustrated exemplary embodiment of the liquid crystal display in FIGS. 14 to 16 may have the features of the liquid crystal display described above with reference to FIGS. 4, 7 and 8.

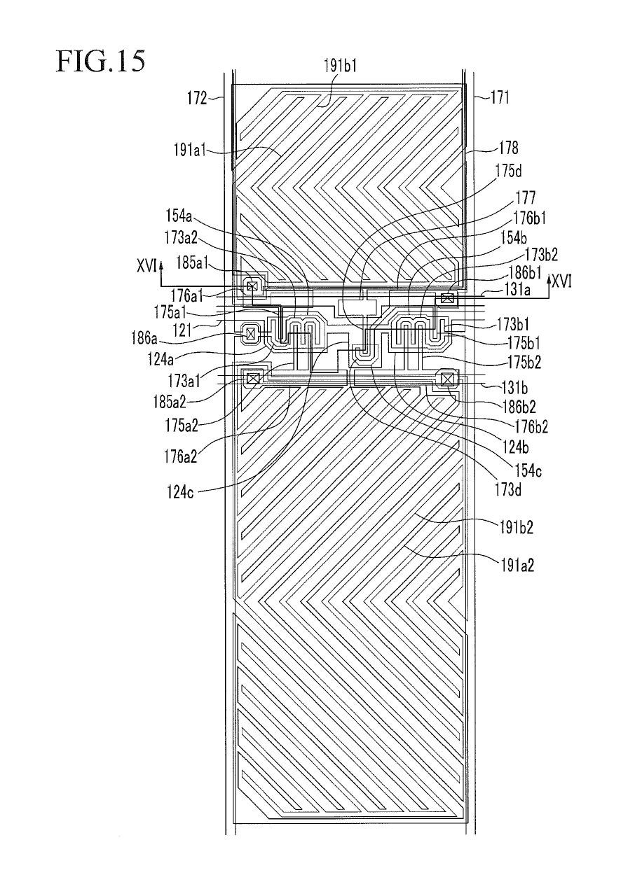

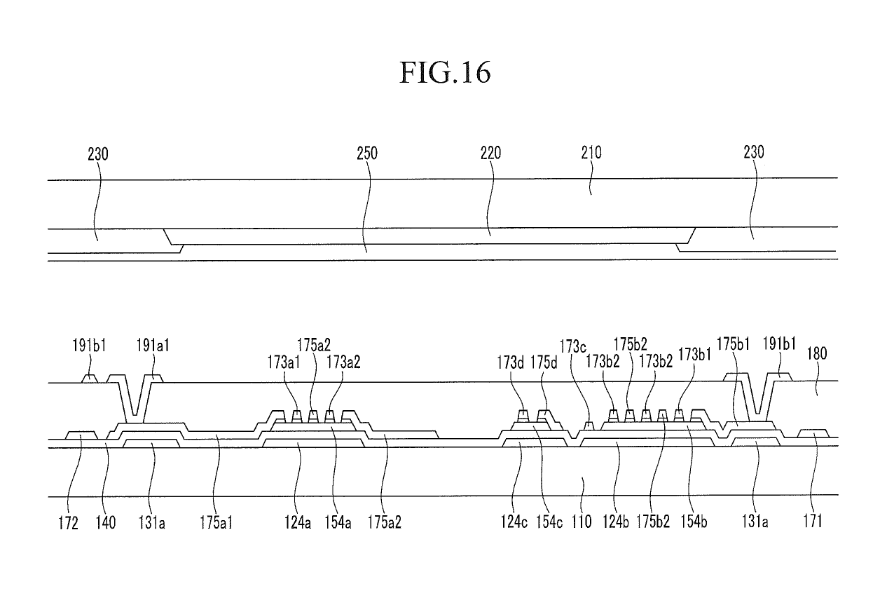

Hereinafter, another alternative exemplary embodiment of a liquid crystal display according to the invention will now be described with reference to FIGS. 14 to 16 together with FIG. 11. FIG. 14 is a schematic circuit diagram of one pixel of another alternative exemplary embodiment of a liquid crystal display according to the invention, FIG. 15 is a top plan view of the liquid crystal display shown in FIG. 14, and FIG. 16 is a cross-sectional view of the liquid crystal display of FIG. 15 taken along line XVI-XVI.

Referring to FIG. 14 and again to FIG. 11, an exemplary embodiment of the liquid crystal display includes a plurality of signal lines Gi, RD, C1 and Dj and a plurality of pixels PX connected to the signal lines and arranged substantially in a matrix form when viewed from a schematic circuit diagram.

The signal lines Gi, RD, C1, and Dj include a gate line Gi that transfers gate signals, a data line Dj that transfers data voltages, a voltage transfer line C1 that transfers a voltage having a constant magnitude, and a reference voltage line RD that transfers a divided reference voltage having a constant magnitude.

Each pixel PX includes a first switching element Qa1, a second switching element Qa2, a third switching element Qb1, a fourth switching element Qb2, and a sixth switching element Qd, which are connected to the signal lines Gi, RD, C1 and Dj, and a first liquid crystal capacitor Cla and a second liquid crystal capacitor Clb, which are connected to the first switching element Qa1, the second switching element Qa2, the third switching element Qb1, the fourth switching element Qb2 and the sixth switching element Qd.

The first switching element Qa1, the second switching element Qa2, the third switching element Qb1, the fourth switching element Qb2 and the sixth switching element Qd are three-terminal elements, e.g., a TFT, provided on the lower panel 100. Control terminals of the first switching element Qa1 and the second switching element Qa2 are connected to the gate line Gi, input terminals of the first switching element Qa1 and the second switching element Qa2 are connected to the voltage transfer line C1, and output terminals of the first switching element Qa1 and the second switching element Qa2 are connected to a first subpixel electrode PEa1 and a second subpixel electrode PEa2 of the first pixel electrode Pea, respectively. The control terminals of the third switching element Qb1 and the fourth switching element Qb2 are connected to the gate lines Gi, input terminals of the third switching element Qb1 and the fourth switching element Qb2 are connected to the data line Dj, and output terminals of the third switching element Qb1 and the fourth switching element Qb2 are connected to a third subpixel electrode PEb1 and a fourth subpixel electrode PEb2 of the second pixel electrode PEb, respectively. A control terminal of the sixth switching element Qd is connected to the gate line Gi, an input terminal the sixth switching element Qd is connected to an output terminal of the third switching element Qb1, and an output terminal the sixth switching element Qd is connected to the reference voltage line RD.

A first liquid crystal capacitor Clca is connected to the first subpixel electrode PEa1 of the first pixel electrode PEa and the third subpixel electrode PEb1 of the second pixel electrode PEb and collectively defined thereby with the liquid crystal layer between the first and third subpixel electrodes PEa1 and PEb1 as an insulating layer, and a second liquid crystal capacitor Clcb is connected to the second subpixel electrode PEa2 of the first pixel electrode PEa and the fourth subpixel electrode PEb2 of the second pixel electrode PEb and collectively defined thereby with the liquid crystal layer between the second and fourth subpixel electrodes PEa2 and PEb2 as an insulating layer.

When a gate-on signal is applied to the gate line Gi, the first to fourth switching elements Qa1, Qa2, Qb1 and Qb2 and the sixth switching element Qd, which are connected to the gate line Gi, are turned on. Accordingly, the third voltage VC having a predetermined magnitude applied to the voltage transfer line C1 is applied to the first subpixel electrode PEa1 and the second subpixel electrode PEa2 of the first pixel electrode PEa through the turned-on first switching element Qa1 and second switching element Qa2, and the first data voltage Vd1 applied to the data line Dj is applied to the third subpixel electrode PEb1 and the fourth subpixel electrode PEb2 of the second pixel electrode PEb through the turned-on third switching element Qb1 and fourth switching element Qb2. In such an embodiment, magnitudes of the third voltages VC applied to the first subpixel electrode PEa1 and the second subpixel electrode PEa2 of the first pixel electrode PEa are substantially the same as each other, and magnitudes of the first data voltages Vd1 applied to the third subpixel electrode PEb1 and the fourth subpixel electrode PEb2 of the second pixel electrode PEb are substantially the same as each other. Accordingly, the first and second liquid crystal capacitors Clca and Clcb are charged by substantially the same value corresponding to a difference between the third voltage VC and the first data voltage Vd1, and the first data voltage Vd1 charged in the third subpixel electrode PEb1 of the second pixel electrode PEb is divided through the turned-on sixth switching element Qd to be lowered to the second data voltage Vd2. Accordingly, the magnitude of the second data voltage Vd2 of the third subpixel electrode PEb1 is lower than the magnitude of the data voltage applied to the fourth subpixel electrode PEb2.

In an exemplary embodiment, as described above, a voltage difference ΔVh between the first subpixel electrode PEa1 and the third subpixel electrode PEb1 is greater than a voltage difference ΔVl between the second subpixel electrode PEa2 and the fourth subpixel electrode PEb2, such that the charged voltage of the first liquid crystal capacitor Clca is greater than the charged voltage of the second liquid crystal capacitor Clcb.

In such an embodiment, the charged voltages of the first and second liquid crystal capacitors Clca and Clcb have different gamma curves in a first region defined by the first subpixel electrode PEa1 of the first pixel electrode PEa and the third subpixel electrode PEb1 of the second pixel electrode PEb and a second region defined by the second subpixel electrode PEa2 of the first subpixel electrode PEa and the fourth subpixel electrode PEb2 of the second pixel electrode PEb, and the gamma curve of one pixel voltage is a curve acquired by synthesizing the different gamma curves. The synthesized gamma curve in the front may be controlled to be substantially the same as a reference gamma curve in the front, and the synthesized gamma curve in the side may be controlled to be substantially close or similar to the reference gamma curve in the front. In such an embodiment, side visibility is substantially improved by converting the image data.

In an exemplary embodiment, a voltage having a predetermined magnitude and the data voltage are applied to one pixel PX to generate the electric field in the liquid crystal layer, the magnitude of the driving voltage may increase, the response speed of the liquid crystal molecule may increase, and the transmittance of the liquid crystal display may be improved. In an exemplary embodiment, when the switching element in one pixel is turned off, all the voltages applied to the first and second pixel electrodes PEa and PEb, which generate the electric field in the liquid crystal layer, drop down by a kickback voltage thereof, such that the charged voltage of the pixel PX is not substantially changed. Accordingly, display characteristics of the liquid crystal display are substantially improved.

In an exemplary embodiment, one pixel PX area may be divided into two regions having different luminances for one data voltage, such that an image viewed from the side may be substantially close or similar to an image viewed from the front, the side visibility is thereby substantially improved, and the transmittance substantially increases.

Hereinafter, an exemplary embodiment of the liquid crystal display shown in FIG. 14 will be described in greater detail with reference to FIGS. 15 and 16.

Referring to FIGS. 15 and 16, the liquid crystal display includes two panels, e.g., a lower panel 100 and an upper panel 200, disposed opposite to each other and a liquid crystal layer 3 interposed between the two panels 100 and 200.

Hereinafter, the lower panel 100 will now be described.

The lower panel 100 includes an insulation substrate 110. The lower panel 100 further includes gate conductors including a plurality of gate lines 121 and a plurality of storage electrode lines 131a and 131b provided on the insulation substrate 110.

The gate lines 121 transfer gate signals and extend substantially in a horizontal direction, and each of the gate lines 121 includes a first gate electrode 124a, a second gate electrode 124b and a third gate electrode 124c.

The lower panel 100 further includes a gate insulating layer 140 disposed on the gate conductor.

The lower panel 100 includes a first semiconductor 154a, a second semiconductor 154b and a third semiconductor 154c, which include hydrogenated amorphous or polycrystalline silicon, for example, on the gate insulating layer 140.

The lower panel 100 includes a pair of ohmic contacts on each of the semiconductors 154a, 154b or 154c.

The lower panel 100 further includes a voltage transfer line 172, a data line 171, and a data conductor including a first drain electrode 175a1, a second drain electrode 175a2, a third drain electrode 175b1, a fourth drain electrode 175b2, a sixth drain electrode 175d and a reference voltage line 178, disposed on the ohmic contacts and the gate insulating layer 140.

The voltage transfer line 172 includes a first source electrode 173a1 and a second source electrode 173a2 extending toward the first gate electrode 124a and the data line 171 includes a third source electrode 173b1 and a fourth source electrode 173b2 extending toward the second gate electrode 124b.

The reference voltage line 178 includes two vertical portions substantially parallel to each other and a horizontal portion connecting two vertical portions to each other. The two vertical portions of the reference voltage line are connected by the horizontal portion, such that delay of the signal flowing in the reference voltage line 178 may be effectively prevented. In an exemplary embodiment, the reference voltage line 178 further includes an extension portion 179.

The first gate electrode 124a, the first source electrode 173a1 and the first drain electrode 175a1 define a first TFT Qa1 together with a first semiconductor island 154a, and a channel of the first TFT Qa1 is formed in the semiconductor 154a between the source electrode 173a1 and the drain electrode 175a1. The second gate electrode 124a2, the second source electrode 173a2 and the second drain electrode 175a2 define a second TFT Qa2 together with the first semiconductor island 154a, and a channel of the second TFT Qa2 is formed in the semiconductor 154a between the source electrode 173a2 and the drain electrode 175a2.

The second gate electrode 124b, the third source electrode 173b1 and the third drain electrode 175b1 define a third TFT Qb1 together with the second semiconductor island 154b, the second gate electrode 124b, the fourth source electrode 173b2 and the fourth drain electrode 175b2 define a fourth TFT Qb2 together with the second semiconductor island 154b, and the third gate electrode 124c, a sixth source electrode 173d and the sixth drain electrode 175d define a sixth TFT Qd together with the third semiconductor island 154c. The sixth source electrode 173d is connected to the third drain electrode 175b1.

A passivation layer 180 is disposed on the data conductors 171, 172, 173c, 175a1, 175a2, 175b1, 175b2, 175d and 178 and the exposed portions of the semiconductors 154a, 154b, and 154c.

A first contact hole 185a1 exposing the first extension portion 176a1 of the first drain electrode 175a1, a second contact hole 185a2 exposing the second extension portion 176a2 of the second drain electrode 175a2, a third contact hole 185b1 exposing the third extension portion 176b1 of the third drain electrode 175b1 and a fourth contact hole 185b2 exposing the fourth extension portion 176b2 of the fourth drain electrode 175b2 are formed through the passivation layer 180. In an exemplary embodiment, a fifth contact hole 186a partially exposing the voltage transfer line 172, the first source electrode 173a1 and the second source electrode 173a2 is formed through the passivation layer 180. In such an embodiment, the voltage transfer line 172 is connected with a connection part through the fifth contact hole 186a to transfer the voltages having the same magnitude to adjacent pixels. Pixel electrodes including a first pixel electrode 191a and a second pixel electrode 191b is disposed on the passivation layer 180. The first pixel electrode 191a includes a first subpixel electrode 191a1 and a second subpixel electrode 191a2, and the second pixel electrode 191b includes a third subpixel electrode 191b1 and a fourth subpixel electrode 191b2.

Each of the first to fourth subpixel electrodes 191a1, 191a2, 191b1 and 191b2 has a stem extending along an edge of the pixel area and a plurality of branches protruding from the stem. The branches of the first subpixel electrode 191a1 and the branches of the third subpixel electrode 191b1 are engaged with each other at a predetermined interval and alternately disposed in the first region of the pixel area. The branches of the second subpixel electrode 191a2 and the branches of the fourth subpixel electrode 191b2 are engaged with each other at a predetermined interval and alternately disposed in the second region of the pixel area.

The first subpixel electrode 191a1 of the first pixel electrode 191a is physically and electrically connected with the first drain electrode 175a1 through the first contact hole 185a1, and the second subpixel electrode 191a2 of the first pixel electrode 191a is physically and electrically connected with the second drain electrode 175a2 through the second contact hole 185a2, thereby receiving the voltage transferred through the voltage transfer line 172. The third subpixel electrode 191b1 of the second pixel electrode 191b is physically and electrically connected with the third drain electrode 175b1 through the third contact hole 185b1, and the fourth subpixel electrode 191b2 of the second pixel electrode 191b is physically and electrically connected with the fourth drain electrode 175b2 through the fourth contact hole 185b2, thereby receiving the data voltage flowing in the data line 171.

The extension portions 176a1, 176a2, 176b1 and 176b2 of the drain electrodes 175a1, 175a2, 175b1 and 175b2, which are connected with the first pixel electrode 191a and the second pixel electrode 191b, define the storage capacitor by overlapping the storage electrode with the gate insulating layer 140 interposed therebetween, and the storage capacitor reinforces voltage storage capacity of the liquid crystal capacitors Clca and Clcb.

In an exemplary embodiment, the voltages applied to the voltage transfer line 172 and the reference voltage line 178 may be different by a predetermined magnitude. In an exemplary embodiment, the voltage difference between the voltage transfer line 172 and the reference voltage line 178 the voltage transfer line 172 and the reference voltage line 178 may be in a range from about 1 volt (V) to about 4 volts (V).

In an exemplary embodiment, a lower alignment layer is provided, e.g., coated, on the inner surface of the panel 100, and the lower alignment layer may be a vertical alignment layer. Although not shown, a polymer layer may be disposed on the lower alignment layer, and the polymer layer may include a polymer branch formed along an initial alignment direction of the liquid crystal molecule 31. The polymer layer may be formed by light-exposing and polymerizing a prepolymer of a monomer cured by polymerization due to light, e.g., ultraviolet rays and may control an alignment force of the liquid crystal molecule according to the polymer branch.

Hereinafter, the upper panel 200 will now be described.

The upper panel 200 include an insulation substrate 210 including transparent glass or plastic, for example. The upper panel 200 include a light blocking member 220 disposed on the insulation substrate 210.

The upper panel 200 includes a plurality of color filters 230 disposed on the insulation substrate 210 and the light blocking member 220. In an exemplary embodiment, the upper panel 200 includes an overcoat 250 disposed on the color filter 230 and the light blocking member 220. In an alternative exemplary embodiment, the overcoat 250 may be omitted.

In an exemplary embodiment, an upper alignment layer (not shown) is provided, e.g., coated, on the inner surface of the upper panel 200, and the upper alignment layer may be a vertical alignment layer. In an exemplary embodiment, although not shown, a polymer layer may be disposed on the upper alignment layer. In an exemplary embodiment, the polymer layer may be formed by light-exposing a prepolymer of a monomer cured by polymerization due to the light of ultraviolet rays and may control an alignment force of the liquid crystal molecule. The polymer layer may include a polymer branch formed along an initial alignment direction of the liquid crystal molecule.

In an exemplary embodiment, polarizers (not shown) may be provided on the outer surfaces of the lower and upper panels 100 and 200.

The liquid crystal layer 3, interposed between the lower panel 100 and the upper panel 200, includes the liquid crystal molecules 31 having positive dielectric anisotropy, and a longitudinal axis of the liquid crystal molecules 31 may be aligned substantially perpendicular to the surfaces of the lower and upper panels 100 and 200 when the electric field is not generated therein.

When voltages having different magnitudes are applied to the first pixel electrode 191a and the second pixel electrode 191b, the electric field substantially horizontal to the surfaces of the lower and upper panels 100 and 200 is generated. In such an embodiment, the liquid crystal molecules 31 of the liquid crystal layer 3, which is initially vertically aligned with respect to the surfaces of the lower and upper panels 100 and 200, respond to the electric field, such that the longitudinal axes of the liquid crystal molecules 31 are inclined substantially parallel to the electric field direction, and a degree of variation in the polarization of the incident light in the liquid crystal layer 3 varies according to the inclined degree of the liquid crystal molecules 31. The variation in the polarization leads to variation in transmittance due to the polarizer, thereby displaying the image in the liquid crystal display.

In an exemplary embodiment, an area of a region occupied by the first liquid crystal capacitor Clca, that is, the region defined by the first subpixel electrode PEa1 of the first pixel electrode PEa and the third subpixel electrode PEb1 of the second pixel electrode PEb is less than the area of a region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively large region is substantially uniformly maintained, and the charged voltage of the first liquid crystal capacitor Clca occupying the relatively small region increases, such that gamma curves of the charged voltages of the first and second liquid crystal capacitors Clca and Clcb become different. In such an embodiment, the charged voltage of the first liquid crystal capacitor Clca having the relatively small area and the relatively high charged voltage substantially relates to an increase of luminance in the low gray. Accordingly, when an image of low gray is displayed, the transmittance in the side may be effectively prevented from being substantially increased as compared with the transmittance in the front such that distortion in visibility may be substantially reduced.

In an alternative exemplary embodiment of the liquid crystal display according to the invention, an area of a region occupied by the first liquid crystal capacitor Clca, that is, the region defined by the first subpixel electrode PEa1 of the first pixel electrode PEa and the third subpixel electrode PEb1 of the second pixel electrode PEb may be greater than the area of a region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively small region is substantially uniformly maintained, and the charged voltage of the first liquid crystal capacitor Clca occupying the relatively large region increases, such that gamma curves of the charged voltages of the first and second liquid crystal capacitors Clca and Clcb become different. In such an embodiment, luminance in high gray may be determined based on the charged voltages of the first liquid crystal capacitor Clca and the second liquid crystal capacitor Clcb, and the entire luminance of the liquid crystal display may increase due to the relatively large area of the first liquid crystal capacitor Clca.

The illustrated exemplary embodiment with reference to FIGS. 14 to 16 may have the features of the liquid crystal display described above with reference to FIGS. 4, 7, and 8 and the liquid crystal display described above with reference to FIGS. 10, 12, and 13.

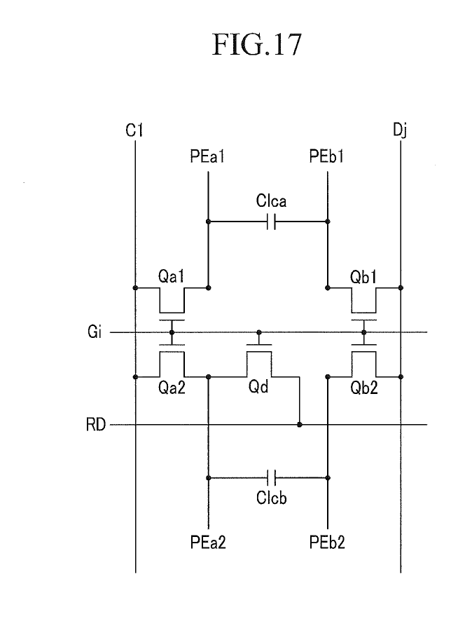

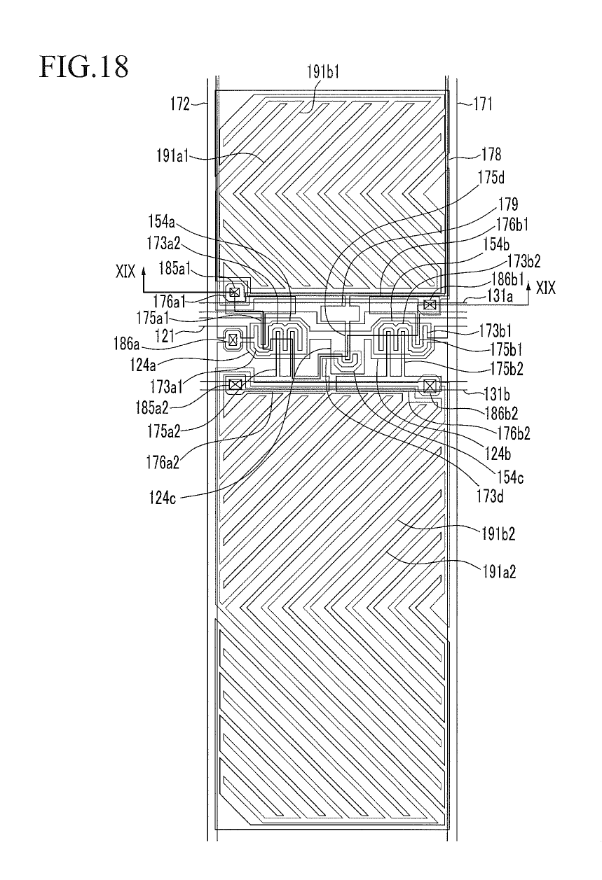

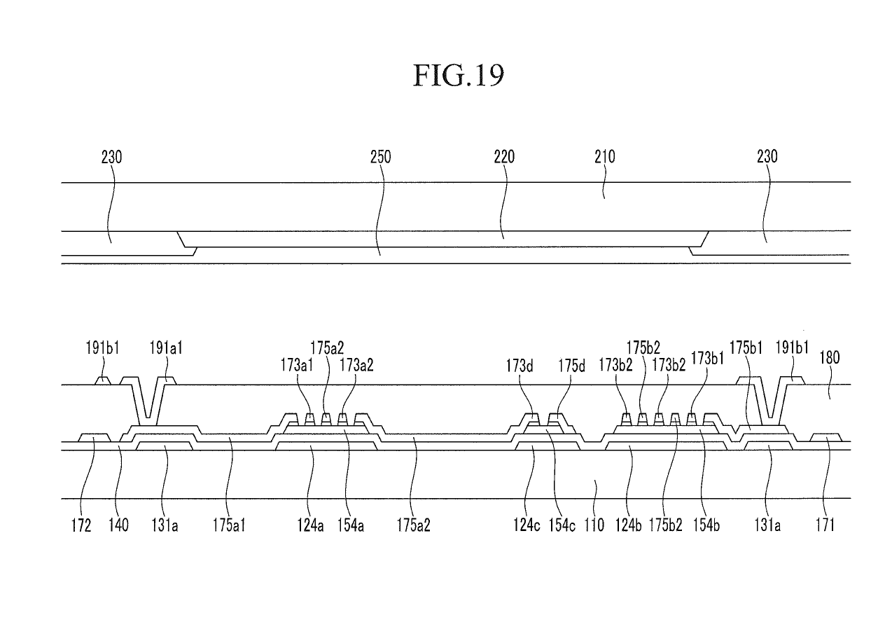

Hereinafter, another alternative exemplary of a liquid crystal display according to the invention will be described with reference to FIGS. 17 to 19 together with FIG. 5. FIG. 17 is a schematic circuit diagram of one pixel of another alternative exemplary embodiment of a liquid crystal display according to still yet another exemplary embodiment of the present invention, FIG. 18 is a top plan view of the liquid crystal display shown in FIG. 17, and FIG. 19 is a cross-sectional view of the liquid crystal display of FIG. 18 taken along line XIX-XIX.

The liquid crystal display shown in FIGS. 17 to 19 is substantially the same as the liquid crystal display shown in FIGS. 14 to 16 except the connection of the sixth switching element Qd. The same or like elements shown in FIGS. 17 to 19 have been labeled with the same reference characters as used above to describe the exemplary embodiments of the liquid crystal display shown in FIGS. 14 to 16, and any repetitive detailed description thereof will hereinafter be omitted or simplified.

Referring to FIG. 17, in an exemplary embodiment of the liquid crystal display, an input terminal of the sixth switching element Qd is not connected to an output terminal of the third switching element Qb1 connected to the third subpixel electrode PEb1 of the second pixel electrode PEb, but connected to an output terminal of the second switching element Qa2 connected to the second subpixel electrode PEa2 of the first pixel electrode PEa. Accordingly, the voltages transferred through the voltage transfer line C1 are charged by the same magnitude in the first subpixel electrode PEa1 and the second subpixel electrode PEa2 of the first pixel electrode PEa and then, a portion of the voltages of the second subpixel electrode PEa2 are divided through the sixth switching element Qd.

Accordingly, in such an embodiment, similarly to the liquid crystal display of FIG. 5, the charged voltage of the second liquid crystal capacitor Clcb between the fourth subpixel electrode PEb2 and the second subpixel electrode PEa2 is lower than the charged voltage of the first liquid crystal capacitor Clca between the third subpixel electrode PEb1 and the first subpixel electrode PEa1.

Referring to FIGS. 18 and 19, the sixth source electrode 173d is not connected to the third extension portion 176b1 of the third drain electrode 175b1, but connected to the second extension portion 176a2 of the second drain electrode 175a2.

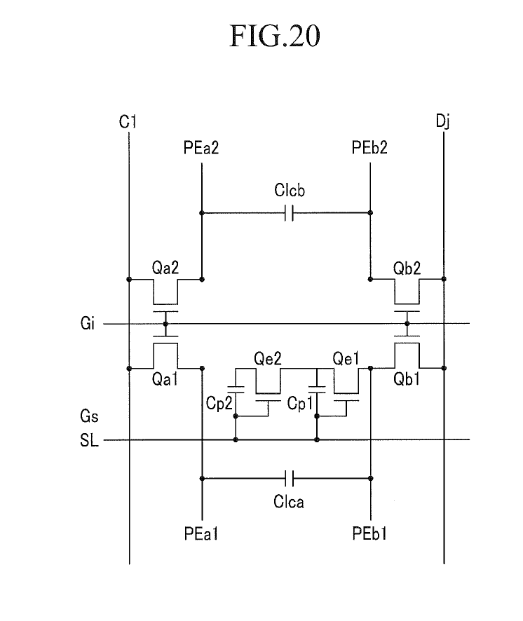

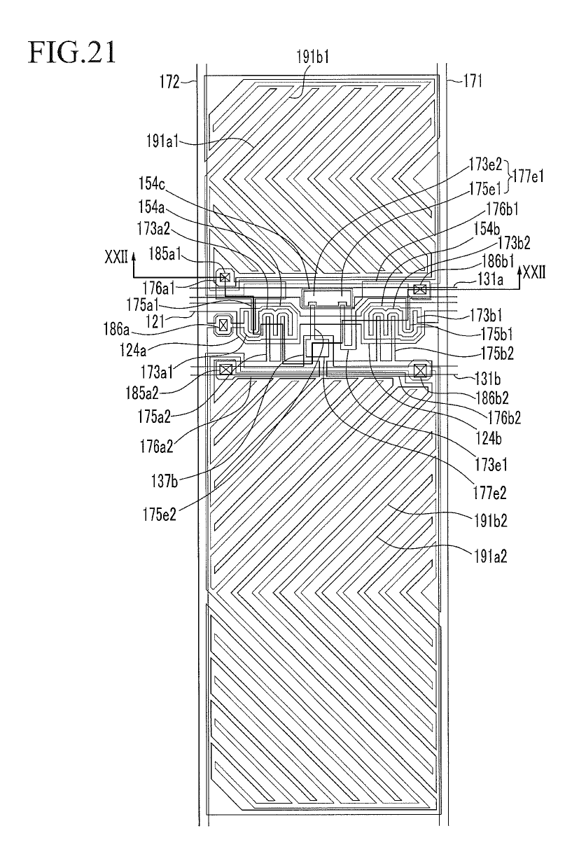

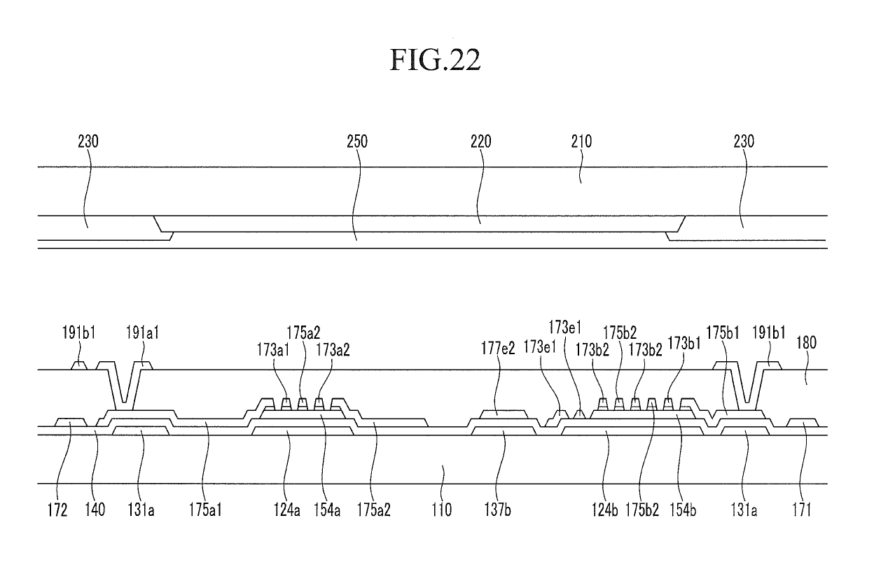

Hereinafter, another alternative exemplary embodiment of a liquid crystal display according to the invention will be described with reference to FIGS. 20 to 22 together with FIG. 11. FIG. 20 is a schematic circuit diagram of one pixel of an alternative exemplary embodiment of a liquid crystal display according the invention, FIG. 21 is a top plan view of the liquid crystal display shown in FIG. 20, and FIG. 22 is a cross-sectional view of the liquid crystal display of FIG. 21 taken along line XXII-XXII.

Referring to FIG. 20, an exemplary embodiment of the liquid crystal display includes a plurality of signal lines Gi, SL, C1 and Dj and a plurality of pixels PX connected to the signal lines and arranged substantially in a matrix form when viewed from a schematic circuit diagram.

The signal lines Gi, SL, C1 and Dj include a gate line Gi that transfers gate signals, a data line Dj that transfers data voltages, a voltage transfer line C1 that transfers a voltage having a constant magnitude, and a common voltage line SL that transfers a voltage having a constant magnitude.

Each pixel PX includes a first switching element Qa1, a second switching element Qa2, a third switching element Qb1, a fourth switching element Qb2, a seventh switching element Qe1 and an eighth switching element Qe2, which are connected to the signal lines Gi, SL, C1 and Dj, and a first liquid crystal capacitor Cla and a second liquid crystal capacitor Clb, which are connected to the first switching element Qa1, the second switching element Qa2, the third switching element Qb1, the fourth switching element Qb2, the seventh switching element Qe1 and the eighth switching element Qe2.

The first switching element Qa1, the second switching element Qa2, the third switching element Qb1, the fourth switching element Qb2, the seventh switching element Qe1 and the eighth switching element Qe2 are three-terminal elements, e.g., a TFT, provided in the lower panel 100. Control terminals of the first switching element Qa1 and the second switching element Qa2 are connected to the gate line Gi, input terminals of the first switching element Qa1 and the second switching element Qa2 are connected to the voltage transfer line C1, and output terminals of the first switching element Qa1 and the second switching element Qa2 are connected to a first subpixel electrode PEa1 and a second subpixel electrode PEa2 of the first pixel electrode Pea, respectively. The control terminals of the third switching element Qb1 and the fourth switching element Qb2 are connected to the gate lines Gi, input terminals of the third switching element Qb1 and the fourth switching element Qb2 are connected to the data line Dj, and output terminals of the third switching element Qb1 and the fourth switching element Qb2 are connected to a third subpixel electrode PEb1 and a fourth subpixel electrode PEb2 of the second pixel electrode PEb, respectively. A control terminal of the seventh switching element Qe1 is connected to the common voltage line SL, an input terminal of the seventh switching element Qe1 is connected to an output terminal of the third switching element Qb1, and an output terminal of the seventh switching element Qe1 is connected to a first step-down capacitor Cp1. Two terminals of the first step-down capacitor Cp1 are connected to the output terminal of the seventh switching element Qe1 and the common voltage line SL. A control terminal of the eighth switching element Qe2 is connected to the common voltage line SL, an input terminal of the eighth switching element Qe2 is connected to an output terminal of the seventh switching element Qe1, and an output terminal of the eighth switching element Qe2 is connected to a second step-down capacitor Cp2. Two terminals of the second step-down capacitor Cp2 are connected to the output terminal of the eighth switching element Qe2 and the common voltage line SL. In such an embodiment, the first step-down capacitor Cp1 and the second step-down capacitor Cp2 may be defined by overlapping the output terminals of the seventh switching element Qe1 and the eighth switching element Qe2 and a portion of the common voltage line SL with the insulator interposed therebetween.

In an exemplary embodiment, two step-down capacitors Cp1 and Cp2 connected with two TFTs, e.g., the seventh TFT Qe1 and the eighth TFT Qe2, are included. In an alternative exemplary embodiment, only one step-down capacitor connected to only the seventh TFT Qe1 may be included, and the eighth TFT Qe2 and the second step-down capacitor Cp2 connected to the eight TFT Qe2 may be omitted.

A first liquid crystal capacitor Clca is connected to the first subpixel electrode PEa1 of the first pixel electrode PEa and the third subpixel electrode PEb1 of the second pixel electrode PEb and collectively defined thereby with the liquid crystal layer between two subpixel electrodes as an insulating layer and a second liquid crystal capacitor Clcb is connected to the second subpixel electrode PEa2 of the first pixel electrode PEa and the fourth subpixel electrode PEb2 of the second pixel electrode PEb and collectively defined thereby with the liquid crystal layer between two subpixel electrodes as an insulating layer.

When a gate-on signal is applied to the gate line Gi, the first to fourth switching elements Qa1, Qa2, Qb1 and Qb2, which are connected to the gate line Gi, are turned on. Accordingly, the third voltages VC having a predetermined magnitude applied to the voltage transfer line C1 are applied to the first subpixel electrode PEa1 and the second subpixel electrode PEa2 of the first pixel electrode PEa through the turned-on first switching element Qa1 and second switching element Qa2, and the first data voltage Vd1 applied to the data line Dj is applied to the third subpixel electrode PEb1 and the fourth subpixel electrode PEb2 of the second pixel electrode PEb through the turned-on third switching element Qb1 and fourth switching element Qb2. In such an embodiment, magnitudes of the third voltages VC applied to the first subpixel electrode PEa1 and the second subpixel electrode PEa2 of the first pixel electrode PEa are substantially the same as each other, and magnitudes of the first data voltages Vd1 applied to the third subpixel electrode PEb1 and the fourth subpixel electrode PEb2 of the second pixel electrode PEb are substantially the same as each other. Accordingly, the first and second liquid crystal capacitors Clca and Clcb are charged by the same value corresponding to a difference between the third voltage VC and the first data voltage Vd1, and the first data voltage Vd1 charged in the third subpixel electrode PEb1 of the second pixel electrode PEb is decompressed through the seventh switching element Qe1 and the eighth switching element Qe2 to be lowered to the second data voltage Vd2. Accordingly, the magnitude of the second data voltage Vd2 of the third subpixel electrode PEb1 is lower than the magnitude of the data voltage applied to the fourth subpixel electrode PEb2.

In an exemplary embodiment, a voltage difference ΔVh between the first subpixel electrode PEa1 and the third subpixel electrode PEb1 is greater than a voltage difference ΔVl between the second subpixel electrode PEa2 and the fourth subpixel electrode PEb2, such that the charged voltage of the first liquid crystal capacitor Clca is greater than the charged voltage of the second liquid crystal capacitor Clcb.

In such an embodiment, the charged voltages of the liquid crystal capacitors Clca and Clcb have different gamma curves in a first region defined by the first subpixel electrode PEa1 of the first pixel electrode PEa and the third subpixel electrode PEb1 of the second pixel electrode PEb and in a second region defined by the second subpixel electrode PEa2 of the first pixel electrode PEa and the fourth subpixel electrode PEb2 of the second pixel electrode PEb, and the gamma curve of one pixel voltage is a curve acquired by synthesizing the different gamma curves. The synthesized gamma curve in the front may be controlled to be substantially identical to a reference gamma curve in the front, and the synthesized gamma curve in the side may be controlled to be substantially close or similar to the reference gamma curve in the front. In such an embodiment, side visibility is substantially improved by converting the image data.

In such an embodiment, the first voltage having a predetermined magnitude and the data voltage are applied to one pixel PX to generate the electric field in the liquid crystal layer, the magnitude of the driving voltage may increase, the response speed of the liquid crystal molecule may increase, and the transmittance of the liquid crystal display may be improved. When the switching element in one pixel is turned off, all the voltages applied to the first and second pixel electrodes PEa and PEb, which generate the electric field in the liquid crystal layer, drop down by a kickback voltage thereof such that the charged voltage of the pixel PX is not substantially changed. Accordingly, display characteristics of the liquid crystal display are substantially improved.

In an exemplary embodiment, one pixel PX area may be divided into two regions having different luminances for one data voltage, such that an image viewed from the side may be substantially close or similar to an image viewed from the front, the side visibility is thereby substantially improved, and the transmittance substantially increases.

Hereinafter, the exemplary embodiment of the liquid crystal display shown in FIG. 20 will be described in greater detail with reference to FIGS. 21 and 22.

Referring to FIGS. 21 and 22, the liquid crystal display includes two panels, e.g., a lower panel 100 and an upper panel 200, opposite to each other, and a liquid crystal layer 3 interposed between the two panels 100 and 200.

Hereinafter, the lower panel 100 will be described.

The lower panel 100 includes an insulation substrate 110, and a gate conductor including a plurality of gate lines 121 and a plurality of common voltage lines 131a and 131b on the insulation substrate 110.

The gate lines 121 transfer gate signals and extend substantially in a horizontal direction, each gate line 121 includes a first gate electrode 124a and a second gate electrode 124b, and the first common voltage line 131a includes the third gate electrode 124c.

The lower panel 100 includes a gate insulating layer 140 on the gate conductor.

The lower panel 100 includes a first semiconductor 154a, a second semiconductor 154b, and a third semiconductor 154c, which includes hydrogenated amorphous or polycrystalline silicon, for example, on the gate insulating layer 140.

The lower panel 100 includes a pair of ohmic contacts on each of the first to third semiconductors 154a, 154b or 154c.

The lower panel 100 includes a voltage transfer line 172, a data line 171 and a data conductor, including a first drain electrode 175a1, a second drain electrode 175a2, a third drain electrode 175b1, a fourth drain electrode 175b2, a seventh drain electrode 175e1 and an eighth drain electrode 175e2, on the ohmic contact and the gate insulating layer 140.

The voltage transfer line 172 includes a first source electrode 173a1 and a second source electrode 173a2 extending toward the first gate electrode 124a, and the data line 171 includes a third source electrode 173b1 and a fourth source electrode 173b2 extending toward the second gate electrode 124b.

The third extension portion 176b1 of the third drain electrode 175b1 extends to form a seventh source electrode 173e1, and the seventh source electrode 173e1 faces the seventh drain electrode 175e1. A part of the seventh drain electrode 175e1 forms an eighth source electrode 173e2. Both the seventh drain electrode 175e1 and the eighth source electrode 173e2 are referred to as a seventh extension portion 177e1. The eighth source electrode 173e2 faces the eighth drain electrode 175e2. An eighth extension portion 177e2 of the eighth drain electrode 175e2 overlaps the extension portion 137b of the second common voltage line 131b.

The first gate electrode 124a1, the first source electrode 173a1 and the first drain electrode 175a1 define a first TFT Qa1 together with a first semiconductor island 154a, and a channel of the first TFT Qa1 is formed in the semiconductor 154a between the source electrode 173a1 and the drain electrode 175a1. The second gate electrode 124a2, the second source electrode 173a2 and the second drain electrode 175a2 defined a second TFT Qa2 together with the first semiconductor island 154a, and a channel of the second TFT Qa2 is formed in the semiconductor 154a between the source electrode 173a2 and the drain electrode 175a2.

The second gate electrode 124b, the third source electrode 173b1 and the third drain electrode 175b1 define a third TFT Qb1 together with the second semiconductor island 154b, the second gate electrode 124b, the fourth source electrode 173b2 and the fourth drain electrode 175b2 define a fourth TFT Qb2 together with a second semiconductor island 154b.

The third gate electrode 124c, the seventh source electrode 173e1 and the seventh drain electrode 175e1 defined a seventh TFT Qe1 together with the third semiconductor island 154c. The third gate electrode 124c, the eighth source electrode 173e2 and the eighth drain electrode 175e2 define an eighth TFT Qe2 together with the third semiconductor island 154c. In an exemplary embodiment, two step-down capacitors connected with two TFTs, e.g., the seventh TFT Qe1 and the eighth TFT Qe2, are included. In an alternative exemplary embodiment, only one step-down capacitor connected to only the seventh TFT Qe1 may be included, and the eighth TFT Qe2 and the step-down capacitor connected to the eighth TFT Qe2 may be omitted.

The lower panel may include a passivation layer 180 on the voltage transfer line 172, the data line 171, the data conductors 173c, 175a1, 175a2, 175b1, 175b2, 175c, 173e1, 175e1 and 175e2 and the exposed portions of the semiconductors 154a, 154b and 154c.

A first contact hole 185a1 exposing the first extension portion 176a1 of the first drain electrode 175a1, a second contact hole 185a2 exposing the second extension portion 176a2 of the second drain electrode 175a2, a third contact hole 185b1 exposing the third extension portion 176b1 of the third drain electrode 175b1 and a fourth contact hole 185b2 exposing the fourth extension portion 176b2 of the fourth drain electrode 175b2 are formed through the passivation layer 180.

The lower panel 100 includes a pixel electrode 191 including a first pixel electrode 191a and a second pixel electrode 191b on the passivation layer 180. The first pixel electrode 191a includes a first subpixel electrode 191a1 and a second subpixel electrode 191a2, and the second pixel electrode 191b includes a third subpixel electrode 191b1 and a fourth subpixel electrode 191b2.

Each of the first to fourth subpixel electrodes 191a1, 191a2, 191b1 and 191b2 has a stem extending along an edge of the pixel area and a plurality of branches protruding from the stem. The branches of the first subpixel electrode 191a1 and the branches of the third subpixel electrode 191b1 are engaged with each other at a predetermined interval and alternately disposed in the first region of the pixel area. The branches of the second subpixel electrode 191a2 and the branches of the fourth subpixel electrode 191b2 are engaged with each other at a predetermined interval and alternately disposed in the second region of the pixel area.

The first subpixel electrode 191a1 of the first pixel electrode 191a is physically and electrically connected with the first drain electrode 175a1 through the first contact hole 185a1, and the second subpixel electrode 191a2 of the first pixel electrode 191a is physically and electrically connected with the second drain electrode 175a2 through the second contact hole 185a2, thereby receiving the voltage transferred through the voltage transfer line 172. The third subpixel electrode 191b1 of the second pixel electrode 191b is physically and electrically connected with the third drain electrode 175b1 through the third contact hole 185b1, and the fourth subpixel electrode 191b2 of the second pixel electrode 191b is physically and electrically connected with the fourth drain electrode 175b2 through the fourth contact hole 185b2, thereby receiving the data voltage flowing in the data line 171.

The extension portions 176a1, 176a2, 176b1 and 176b2 of the drain electrodes 175a1, 175a2, 175b1, and 175b2, which are connected with the first pixel electrode 191a and the second pixel electrode 191b, define the storage capacitor by overlapping the storage electrode with the gate insulating layer 140 interposed therebetween, and the storage capacitor reinforces voltage storage capacity of the liquid crystal capacitors Clca and Clcb.

A lower alignment layer is provided, e.g., coated, on the inner surface of the panel 100, and the lower alignment layer may be a vertical alignment layer. Although not shown, a polymer layer may disposed on the lower alignment layer, and the polymer layer may include a polymer branch formed along an initial alignment direction of the liquid crystal molecule 31. In an exemplary embodiment, the polymer layer may be formed by light-exposing and polymerizing a prepolymer of a monomer cured by polymerization due to the light of ultraviolet rays and may control an alignment force of the liquid crystal molecule according to the polymer branch.

Hereinafter, the upper panel 200 will be described.

The upper panel 200 includes an insulation substrate 210 including transparent glass or plastic, for example, and a light blocking member 220 on the insulation substrate 210.

The upper panel 200 includes a plurality of color filters 230 on the insulation substrate 210 and the light blocking member 220, and an overcoat 250 on the color filter 230 and the light blocking member 220. In an alternative exemplary embodiment, the overcoat 250 may be omitted.

An upper alignment layer (not shown) is provided, e.g., coated, on the inner surface of the panel 200, and the upper alignment layer may be a vertical alignment layer. Although not shown, a polymer layer may also be provided on the upper alignment layer. The polymer layer may be formed by light-exposing a prepolymer of a monomer cured by polymerization due to the light of ultraviolet rays and may control an alignment force of the liquid crystal molecule. The polymer layer may include a polymer branch formed along an initial alignment direction of the liquid crystal molecule.

Polarizers (not shown) may be provided on the outer surfaces of the lower and upper panels 100 and 200.

The liquid crystal layer 3 interposed between the lower panel 100 and the upper panel 200 includes the liquid crystal molecule 31 having positive dielectric anisotropy, and a longitudinal axis of the liquid crystal molecules 31 may be aligned substantially perpendicular to the surfaces of the lower and upper panels 100 and 200 when the electric field is not generated therein.

When voltages having different magnitudes are applied to the first pixel electrode 191a and the second pixel electrode 191b, the electric field substantially horizontal to the surfaces of the lower and upper panels 100 and 200 is generated. Then, the liquid crystal molecules of the liquid crystal layer 3, which is initially vertically aligned with respect to the surfaces of the panels 100 and 200, respond to the electric field, such that the longitudinal axes of the liquid crystal molecules are inclined substantially parallel to the electric field direction, and a degree of variation in the polarization of the incident light in the liquid crystal layer 3 varies according to the inclined degree of the liquid crystal molecule. The variation in the polarization leads to variation in transmittance due to the polarizer, thereby displaying the image in the liquid crystal display.

In an exemplary embodiment, an area of a region occupied by the first liquid crystal capacitor Clca, that is, the region defined by the first subpixel electrode PEa1 of the first pixel electrode PEa and the third subpixel electrode PEb1 of the second pixel electrode PEb is less than the area of a region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively large region is substantially uniformly maintained and the charged voltage of the first liquid crystal capacitor Clca occupying the relatively small region increases, such that gamma curves of the charged voltages of the first and second liquid crystal capacitors Clca and Clcb become different. In such an embodiment, the charged voltage of the first liquid crystal capacitor Clca having the relatively small area and the relatively high charged voltage in the low gray substantially relates to an increase in luminance. Accordingly, when an image of low gray is displayed, the transmittance in the side may be effectively prevented from being substantially increased as compared with the transmittance in the front such that distortion in visibility may be substantially reduced.

In an alternative exemplary embodiment of the liquid crystal display according to the invention, an area of a region occupied by the first liquid crystal capacitor Clca, that is, the region defined by the first subpixel electrode PEa1 of the first pixel electrode PEa and the third subpixel electrode PEb1 of the second pixel electrode PEb may be greater than the area of a region occupied by the second liquid crystal capacitor Clcb, that is, the region defined by the second subpixel electrode PEa2 of the first pixel electrode PEa and the fourth subpixel electrode PEb2 of the second pixel electrode PEb. In such an embodiment, the charged voltage of the second liquid crystal capacitor Clcb occupying the relatively small region is substantially uniformly maintained and the charged voltage of the first liquid crystal capacitor Clca occupying the relatively large region increases, such that gamma curves of the charged voltages of the first and second liquid crystal capacitors Clca and Clcb become different from each other. In such an embodiment, luminance in high gray may be determined based on the charged voltages of the first liquid crystal capacitor Clca and the second liquid crystal capacitor Clcb, and the entire luminance of the liquid crystal display may increase due to the relatively large area of the first liquid crystal capacitor Clca.

The illustrated exemplary embodiment with reference to FIGS. 20 to 22 may have the features of the liquid crystal display described above with reference to FIGS. 4, 7, and 8 and the liquid crystal display described above with reference to FIGS. 14 to 16.

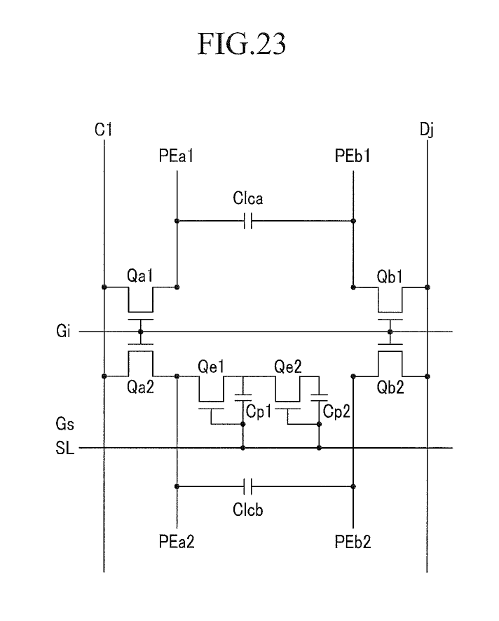

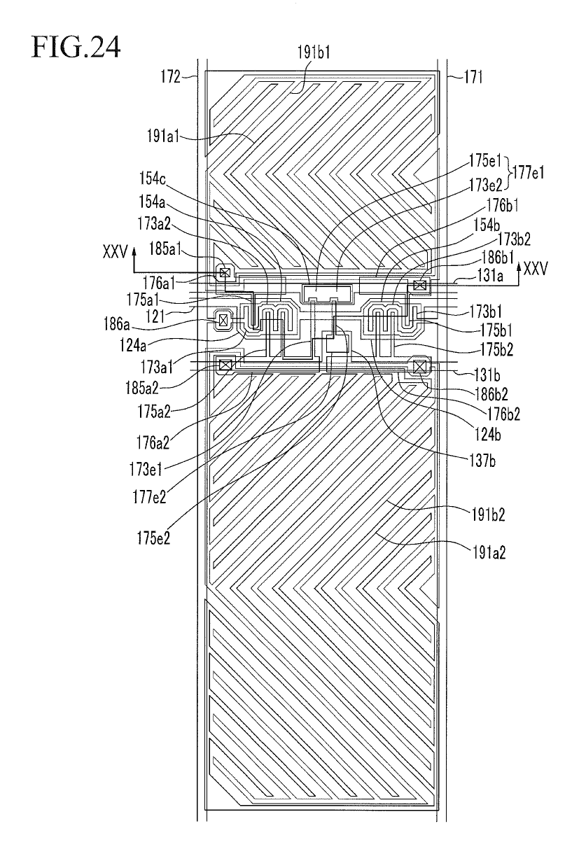

Hereinafter, another alternative exemplary embodiment of a liquid crystal display according to the invention will be described with reference to FIGS. 23 to 25 together with FIG. 5. FIG. 23 is a schematic circuit diagram of one pixel of an exemplary embodiment of a liquid crystal display according to the invention, FIG. 24 is a top plan view of the liquid crystal display shown in FIG. 23, and FIG.

25 is a cross-sectional view of the liquid crystal display of FIG. 24 taken along line XXV-XXV.

The liquid crystal display shown in FIGS. 23 to 25 is substantially the same as the liquid crystal display shown in FIGS. 20 to 22 except the connections of the seventh and eighth switching elements Qe1 and Qe2. The same or like elements shown in FIGS. 23 to 25 have been labeled with the same reference characters as used above to describe the exemplary embodiments of the liquid crystal display shown in FIGS. 20 to 22, and any repetitive detailed description thereof will hereinafter be omitted or simplified.

Referring to FIG. 23, in an exemplary embodiment of the liquid crystal display, an input terminal of the seventh TFT Qe1 is not connected to an output terminal of the third switching element Qb1 connected to the third subpixel electrode PEb1 of the second pixel electrode PEb, but connected to an output terminal of the second switching element Qa2 connected to the second subpixel electrode PEa2 of the first pixel electrode PEa. Accordingly, the voltages transferred through the voltage transfer line C1 are charged by the same magnitude in the first subpixel electrode PEa1 of the first pixel electrode PEa and the second subpixel electrode PEa2 and then, a portion of the voltages of the second subpixel electrode PEa2 are decompressed through the seventh switching element Qe1 and the eighth switching element Qe2.

In such an embodiment, similarly to the exemplary embodiment described with reference to FIG. 5, the charged voltage of the second liquid crystal capacitor Clcb between the fourth subpixel electrode PEb2 and the second subpixel electrode PEa2 is lower than the charged voltage of the first liquid crystal capacitor Clca between the third subpixel electrode PEb1 and the first subpixel electrode PEa1.

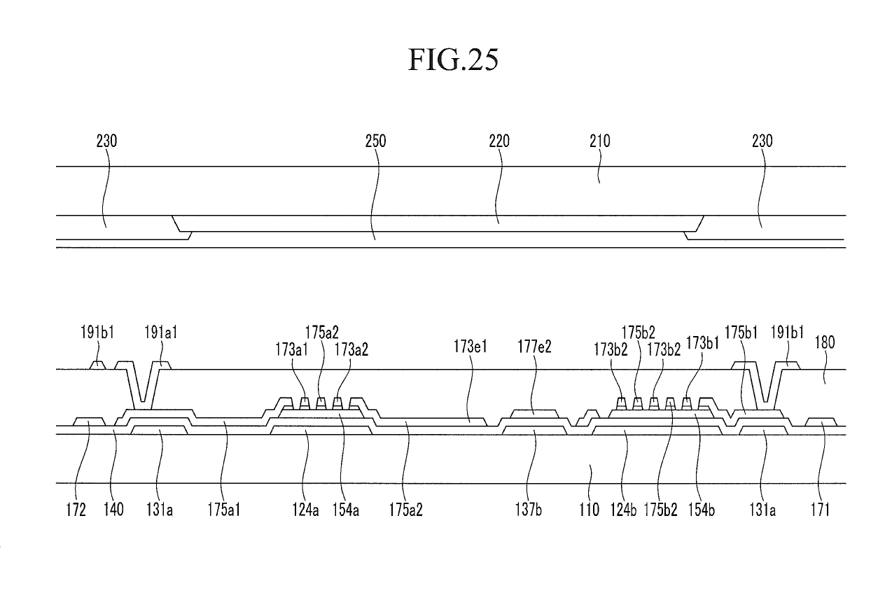

Referring to FIGS. 24 and 25, the seventh source electrode 173e1 is not connected to the third extension portion 176b1 of the third drain electrode 175b1, but connected with the second extension portion 176a2 of the second drain electrode 175a2.

In such an embodiment, the voltage having a predetermined magnitude and the data voltage are applied to one pixel PX to generate the electric field in the liquid crystal layer, the magnitude of the driving voltage may increase, the response speed of the liquid crystal molecule may increase, and the transmittance of the liquid crystal display may be improved. When the switching element in one pixel is turned off, all the voltages applied to the first and second pixel electrodes PEa and PEb, which generate the electric field in the liquid crystal layer, drop down by a kickback voltage thereof such that the charged voltage of the pixel PX is not substantially changed. Accordingly, display characteristics of the liquid crystal display are substantially improved.

In an exemplary embodiment, one pixel PX area may be divided into two regions having different luminances for one data voltage, such that an image viewed from the side may be substantially close or similar to an image viewed from the front, the side visibility is thereby substantially improved, and the transmittance substantially increases.

The layouts and the driving methods of the signal lines and the pixels of the liquid crystal display according to the exemplary embodiment described above may be applied to pixel structures in various forms including the first pixel electrode and the second pixel electrode of which at least some parts are in the same layer and alternately disposed each other.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first substrate;
a second substrate disposed opposite to the first substrate;
a liquid crystal layer interposed between the first and second substrates and including liquid crystal molecules;
a gate line disposed on the first substrate and which transfers a gate signal;
a data line disposed on the first substrate and which transfers a data voltage;
a voltage transfer line disposed on the first substrate and which transfers a voltage having a predetermined magnitude; and
a plurality of pixels disposed on the first substrate, wherein each of the pixels includes a first pixel electrode and a second pixel electrode separated from each other,
wherein the first pixel electrode includes a first subpixel electrode and a second subpixel electrode,
wherein the second pixel electrode includes a third subpixel electrode and a fourth subpixel electrode,
wherein each of the first, second, third and fourth subpixel electrodes includes a stem and a plurality of branch electrodes protruding from the stem,
wherein the branch electrodes of the first subpixel electrode of the first pixel electrode and the branch electrodes of the third subpixel electrode of the second pixel electrode are alternately disposed,
wherein the branch electrodes of the second subpixel electrode of the first pixel electrode and the branch electrodes of the fourth subpixel electrode of the second pixel electrode are alternately disposed, and
wherein a voltage difference between the first subpixel electrode of the first pixel electrode and the third subpixel electrode of the second pixel electrode is greater than a voltage difference between the second subpixel electrode of the first pixel electrode and the fourth subpixel electrode of the second pixel electrode.

2. The liquid crystal display of claim 1, further comprising:
a first switching element connected to the first subpixel electrode of the first pixel electrode;
a second switching element connected to the second subpixel electrode of the first pixel electrode;
a third switching element connected to the third subpixel electrode of the second pixel electrode; and
a fourth switching element connected to the fourth subpixel electrode of the second pixel electrode,
wherein the first switching element and the second switching element are connected to the voltage transfer line, and
wherein the third switching element and the fourth switching element are connected to the data line.

3. The liquid crystal display of claim 2, further comprising:
a fifth switching element connected to an output terminal of the second switching element or an output terminal of the third switching element.

4. The liquid crystal display of claim 3, further comprising:
an additional gate line different from the gate line,
wherein the first to fourth switching elements are connected to the gate line, and the fifth switching element is connected to the additional gate line.

5. The liquid crystal display of claim 4, wherein
an output terminal of the fifth switching element is connected to a step-down capacitor.

6. The liquid crystal display of claim 5, wherein
the liquid crystal layer is substantially vertically aligned when an electric field is not generated in the liquid crystal layer.

7. The liquid crystal display of claim 6, wherein
the voltage transfer line is disposed every three pixels of the plurality of pixels.

8. The liquid crystal display of claim 3, wherein
the first to fifth switching elements are connected to the gate line.

9. The liquid crystal display of claim 8, wherein
an output terminal of the fifth switching element is connected to a step-down capacitor.

10. The liquid crystal display of claim 9, wherein
the liquid crystal layer is substantially vertically aligned when an electric field is not generated in the liquid crystal layer.

11. The liquid crystal display of claim 10, wherein
the voltage transfer line is disposed every three pixels of the plurality of pixels.

12. The liquid crystal display of claim 3, further comprising:
a reference voltage line which transfers a reference voltage having a predetermined magnitude,
wherein a control terminal of the fifth switching element is connected to the reference voltage line.

13. The liquid crystal display of claim 12, wherein
an output terminal of the fifth switching element is connected to a step-down capacitor.

14. The liquid crystal display of claim 13, wherein
the liquid crystal layer is substantially vertically aligned when an electric field is not generated in the liquid crystal layer.

15. The liquid crystal display of claim 14, wherein
the voltage transfer line is disposed every three pixels of the plurality of pixels.

16. The liquid crystal display of claim 2, wherein
two pixels, adjacent to each other in a pixel column direction of the pixels, are connected with the voltage transfer line,
first subpixel electrodes of the two pixels are disposed opposite to each other with respect to the voltage transfer line, and
second subpixel electrodes of the two pixels are disposed opposite to each other with respect to the voltage transfer line.

17. The liquid crystal display of claim 1, wherein
the voltage transfer line is disposed every three pixels of the plurality of pixels.

18. The liquid crystal display of claim 1, wherein
the liquid crystal layer is substantially vertically aligned when an electric field is not generated in the liquid crystal layer.
